(19) United States
(12) Patent Application Publication
(10) Pub. No.: US 2009/0197084 A1
(43) Pub. Date: Aug. 6, 2009

(54) BIOCIDAL FIBERS

(75) Inventors: Gang Sun, Davis, CA (US); Mohammad Reza Badrossamay, Davis, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of California, Oakland, CA (US)

(21) Appl. No.: 12/398,149

(22) Filed: Mar. 4, 2009

Related U.S. Application Data
(63) Continuation of application No. PCT/US2007/077918, filed on Sep. 7, 2007.
(60) Provisional application No. 60/824,812, filed on Sep. 7, 2006.

(51) Int. Cl. C08F 8/22; D02G 3/00

(52) U.S. Cl. 428/401; 525/334.1

(57) ABSTRACT

The present invention provides graft biocidal N-halamine polymers. The biocidal polymers are prepared by contacting precursor graft polymers with a halogen source. The precursor graft polymers are prepared by grafting a polymer, such as a polyolefin, with a vinyl monomer under suitable conditions, for example, a reactive extrusion condition. In one embodiment, the graft polymerization is carried out in the presence of a vinyl monomer and a radical initiator. The biocidal polymers have potent antimicrobial activities against a broad spectrum of microorganisms and virus, such as E. coli and flu viruses.

### CROSS-REFERENCES TO RELATED APPLICATIONS

This application is a continuation application of the PCT Patent Application No. PCT/US2007/077918, filed Sep. 7, 2007, which claims priority to U.S. Provisional Patent Application No. 60/824,812, filed Sep. 7, 2006; the disclosures of each is hereby incorporated by reference in its entirety for all purposes.

### STATEMENT AS TO RIGHTS TO INVENTIONS MADE UNDER FEDERALLY SPONSORED RESEARCH OR DEVELOPMENT

This invention was made with government support under DMI 0323409 awarded by the National Science Foundation. The government may have certain rights in the invention.

### BACKGROUND OF THE INVENTION

Clothing material is the last line of protection for the human body from exposure to any potential hazards. Currently used chemical and biological protective clothing is mostly made of nonwoven fabrics (Wubbe, E. et al., http://www.nonwovens-industry.com/articles/2002/10/making-an-incision-in-the-medical-market.php (2002)). The nonwoven fabrics can resist liquid and aerosol microorganisms and toxic chemicals penetrating through the fabrics due to the dense fiber entanglements and hydrophobic structures (Forsberg, K. et al., “Quick Selection Guide to Chemical Protective Clothing,” Third Edition, by (1997)). In the medical field, nonwovens are used in a variety of applications such as barrier products (drapes, gowns and germ-eliminating products), wound care applications, face masks, and wipes. In the price-sensitive healthcare segment, some institutions have found nonwovens to be a less expensive choice than woven products in certain applications (Bajaj, B., et al., “Protective Clothing” (1992)).

A recent study shows that some bacteria can survive on medical textiles for more than 3 months and longer on synthetic fabrics than on cotton (Sun, Y. et al., Polym Sci Part A. Polym Chem, 39(19):3348 (2001)). This result along with other evidence (Luo, J. et al., Polym Sci Part A. Polym Chem, 44 (11):3588 (2006)) provides that antimicrobial properties are a necessary function on medical and healthcare use textiles and polymers to prevent cross-transmission of diseases. In addition, air and water filtering materials and membranes also require biocidal functionality, particularly rechargeable functionality.

Novel technologies have been developed to incorporate rechargeable biocidal functions to many woven fabric materials (Sun, Y. et al., Polym Sci Part A: Polym Chem, 39(19):3348 (2001); Luo, J. et al., Polym Sci Part A: Polym Chem, 44 (11):3588 (2006); Worley, S. D. et al., U.S. Pat. No. 5,490,983, (Feb. 13, 1996); Worley, S. D. et al., U.S. Pat. No. 5,670,646, (Sep. 23, 1997); Sun, G., U.S. Pat. No. 5,882,327, (Mar. 16, 1999); Worley, S. D. et al., CRC Critical Reviews in Environmental Control 18(2)133-175 (1988); Worley, S. D. et al., Trends in Polymer Science 4(11):364-370 (1996); Sun, G. et al., U.S. Pat. No. 5,882,357, (Mar. 16, 1999); Sun, G. U.S. Pat. No. 6,077,319 (Jun. 20, 2000); Sun, Y. et al. J. Appl. Poly. Sci. 81:517-624 (2001); Lunenschloss, J. et al., Nonwoven bonded fabrics, Halsted Press, Newyork, (1985)). However, these technologies have failed to treat nonwoven fabrics because of dimensional stability and mechanical alteration of these structures during wet finishing treatments. Moreover, most nonwoven fabrics are made of polyolefin, which are the polymers that are hardly modified in regular textile chemical finishing processes. No matter what type of light weight nonwoven fabrics, the manufacturing processes for these nonwoven fabrics involve fiber extrusion under elevated temperatures and direct formation of fabrics from the spun fibers (Henman, T. Degradation and Stabilization of Polyolefins, Applied science Publishers, London, (1983)).

U.S. Pat. No. 5,882,357, issued to Sun et al., on Mar. 16, 1999, discloses durable and regenerable microbiocidal textiles and methods for preparing the same. The microbiocidal textiles are prepared using a wet finishing process to covalently attach a heterocyclic N-halamine to a cellulose-based material or other polymeric material. The biocidal activity of the textiles can be regenerated by washing with a halogenated solution. In addition, U.S. Pat. No. 7,084,208 issued to Sun et al., on Aug. 1, 2006 provides heterocyclic vinylic compounds that can be used to form biocidal polymers. The polymers thus generated can be used alone or can be grafted onto textiles, fabrics and polymers. The polymers can be readily converted to N-halamine structures on exposure to a halogen source such as commercially available chlorine bleach. The N-halamine derivatives exhibit potent antibacterial properties against microoganisms and these properties are durable and regenerable.

Despite the advances in the art, there is a need for grafting halamine precursors onto polyolefin fibers, for example, polypropylene fiber, to make new compositions and efficient processes to produce such fibers. The present invention satisfies these and other needs.

### BRIEF SUMMARY OF THE INVENTION

The present invention relates to grafting halamine precursors onto a polyolefin polymer, for example, polypropylene (PP). The grafting process can be effectuated by various methods such as for example, a fiber extrusion process. Advantageously, in some embodiments of the present invention, the polyolefin fibers, such as the PP fibers so produced have biocidal properties. The chemically modified PP is extruded through a process described herein into microfibers, or sub-microfibers for antimicrobial functionality. Various reactive halamine precursor monomers can be used in the reactive process. The grafted fibers are antimicrobial and their activities against for example, gram-negative E. coli, is exceptional. The biocidal polymers have application in face masks and respirators for prevention of pandemics of e.g., influenza, severe acute respiratory syndrome (SARS) and/or bird flu.

In one aspect, the present invention provides a polyolefin-graft-poly(amine monomer) polymer fiber having a diameter less than 10 μm. The polymer fiber includes a polyolefin main chain and a plurality of poly(amine monomer) side chains, wherein at least one of the side chains is linked to a tertiary carbon on the main chain through either a terminal —CH₂— or a terminal tertiary carbon moiety of the side chains to form a covalent bond and wherein the polyolefin main chain has a structure of formula (I):

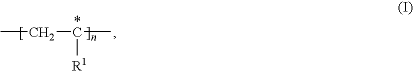

In formula I, R¹ is selected from the group consisting of H, C₁₋₂₀alkyl, cycloalkyl-C₁₋₆alkyl, aryl, aryl-C₂₋₆-alkyl, heteroaryl, heteroaryl-C₂₋₆-alkyl and halide. In one embodiment, the poly(amine monomer) side chains have a structure of formula (II):

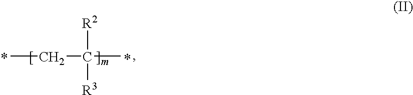

wherein R² is —H or C₁₋₈alkyl. R³ is selected from the group consisting of: —C(O)NH₂, —C(O)NHR^{a}, —NH₂C(O)R^{a}, —NHR^{a}C(O)R^{a}, —R^{b}, —OR^{b}, —R^{c}, R^{c}—C₁₋₆alkyl, R^{c}-aryl and R^{c}—C₁₋₆alkyl-aryl. Each R^{a} is independently C₁₋₈alkyl or aryl. R^{b} is selected from the group consisting of C₁₋₈alkyl, C₁₋₈haloalkyl, aryl, aryl-C₁₋₆alkyl, C₁₋₆alkylaryl, heterocycloalkyl, heterocycloalkyl-C₁₋₆alkyl, heterocycloalkyl-aryl, heterocycloalkyl-C₁₋₆alkyl-aryl, heteroaryl and heteroaryl-C₁₋₆alkyl, each of which is substituted with from 1-3 R⁵ substituents. Each R^{c} is independently a heterocycloalkyl having at least one —NH— group as a ring member, optionally substituted with from 1-3 C₁₋₈alkyl substituents. m is an integer from about 1 to about 20000. n is an integer from about 100 to about 20000. In another embodiment, each of the poly(amine monomer) side chains is a sequence of q structure repeat units independently selected from the group consisting of:

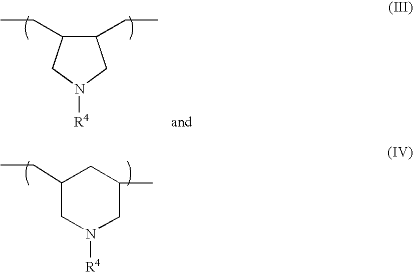

wherein the sequence of q structure repeat units is joined together through carbon-carbon single bonds and each R⁴ is independently selected from the group consisting of aryl-C₁₋₆alkyl, aryl, heteroaryl and heteroaryl-C₁₋₆alkyl, each of which is substituted with from 1-3 R⁵ substituents and R⁶ is —H or C₁₋₄alkyl. The asterisk symbols in formulas I and II represent points of attachment between the main chain and the side chains. Preferably, the side chains are attached to the main chain through the —CH₂— end group.

R⁵ is selected from the group consisting of —OC(O)NHR^{d}, —S(O)₂NHR^{d}, —NHS(O)₂R^{d}, —C(O)NHR^{d}, —NHC(O)R^{d}, —NHC(O)NH₂, —NR^{d}C(O)NH₂, —NR^{d}C(O)NHR^{d}, —NHC(O)NHR^{d}, —NHC(O)N(R^{d})₂, —NHCO₂R^{d}, —NH₂, —NHR^{d}, —NR^{d}S(O)NH₂, —NR^{d}S(O)₂NHR^{d}, —NH₂C(═NR^{d})NH₂, —N═C(NH₂)NH₂, —C(═NR^{d})NH₂, —NH—NHR^{d} and —NHC(O)NHNH₂, wherein each R^{d} is independently an C₁₋₈alkyl or aryl and R^{b} is optionally further substituted with from 1-3 members selected from the group consisting of C₁₋₆alkyl, halogen, —NO₂, —OH, alkoxy, alkoxycarbonyl, carboxyl, —COOH and —CN.

In another aspect, the present invention provides a biocidal polyolefin-graft-poly(amine monomer) polymer. The polymer includes a polyolefin main chain and a plurality of poly(amine monomer) side chains, wherein at least one of the plurality of side chains is linked to either a secondary or a tertiary carbon of the main chain through either a terminal —CH₂— or a terminal tertiary carbon moiety the side chains to form a carbon-carbon single bond and wherein the side chains include at least one member selected from the group consisting of —N(X)— and —NHX, wherein X is selected from the group consisting of —F, —Cl, —Br and —I. In one embodiment, the side chains are linked to the main chain through a —CH₂-end group of the side chains.

In yet another aspect, the present invention provides a method for preparing a poly(α-olefin)-graft-poly(amine monomer) polymer. The method includes admixing a poly(α-olefin) fiber of formula V:

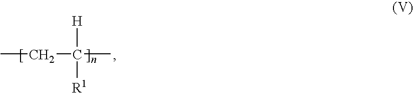

a monomer having formula VI or VII:

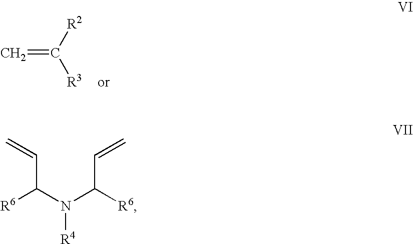

and a free radical generator under conditions sufficient to form a graft polymer, and extruding the product to produce a graft polymer fiber. R¹ is —H or C₁₋₆alkyl. R² is —H or C₁₋₈alkyl. R³ is selected from the group consisting of —C(O)NH₂, —C(O)NHR^{a}, —NH₂C(O)R^{a}, —NHR^{a}C(O)R^{a}, —R^{b}, —OR^{b}, —R^{c}, R^{c}—C₁₋₆alkyl, R¹-aryl and R^{c}—C₁₋₆alkyl-aryl. Each R^{a} is independently C₁₋₈alkyl or aryl. R^{b} is selected from the group consisting of C₁₋₈alkyl, C₁₋₈haloalkyl, aryl, aryl-C₁₋₆alkyl, C₁₋₆alkylaryl, heterocycloalkyl, heterocycloalkyl-C₁₋₆alkyl, heterocycloalkyl-aryl, heterocycloalkyl-C₁₋₆alkyl-aryl, heteroaryl and heteroaryl-C₁₋₆alkyl, each of which is substituted with from 1-3 R⁵. Each R^{c} is heterocycloalkyl having at least one —NH— group as a ring member, optionally substituted with from 1-3 C₁₋₈alkyl substituents. R⁴ is aryl-C₁₋₆alkyl, C₁₋₆alkylaryl, aryl, heteroaryl and heteroaryl-C₁₋₆alkyl, each of which is substituted with from 1-3 R⁵ substituents. R⁶ is —H or C₁₋₄alkyl. In one embodiment, R⁶ is —H.

In still another aspect, the present invention provides a method for preparing a polyolefin-graft-poly(amine monomer) biocidal fiber. The method includes admixing a polyolefin fiber, a vinyl monomer having one or more —NH— or —NH₂ groups and a free radical initiator in an extruder under conditions sufficient to form a graft polymer, extruding the graft polymer to produce a graft polymer fiber, and contacting the graft polymer fiber with a halogen generating source under conditions sufficient to form a biocidal fiber containing one or more —N(X)— and —NHX groups, wherein X is selected from the group consisting of —F, —Cl, —Br and —I. In one embodiment, the method includes admixing a poly(α-olefin) fiber of formula V:

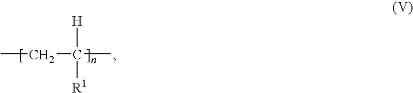

a monomer having formula VI or VII:

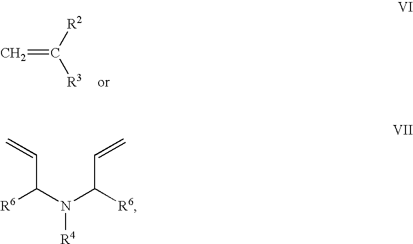

and a free radical generator in an extruder under conditions sufficient to form a graft polymer; extruding the graft polymer to produce a graft polymer fiber; and contacting the graft polymer fiber with a halogen generating source under conditions sufficient to form a biocidal fiber. R² is —H or C₁₋₈alkyl. R³ is selected from the group consisting of —C(O)NH₂, —C(O)NHR^{a}, —NH₂C(O)R^{a}, —NHR^{a}C(O)R^{a}, —R^{b}, —OR^{b}, —R^{c}, R^{c}—C₁₋₆alkyl, R-aryl and R^{c}—C₁₋₆alkyl-aryl. Each R^{a} is independently C₁₋₈alkyl or aryl. R^{b} is selected from the group consisting of C₁₋₈alkyl, C₁₋₈haloalkyl, aryl, aryl-C₁₋₆alkyl, C₁₋₆alkylaryl, heterocycloalkyl, heterocycloalkyl-C₁₋₆alkyl, heterocycloalkyl-aryl, heterocycloalkyl-C₁₋₆alkyl-aryl, heteroaryl and heteroaryl-C₁₋₆alkyl, each of which is substituted with from 1-3 R⁵. R⁴ is aryl-C₁₋₆alkyl, C₁₋₆alkylaryl, aryl, heteroaryl and heteroaryl-C₁₋₆alkyl, each of which is substituted with from 1-3 R⁵ substituents; and R⁶ is —H or C₁₋₄alkyl.

In another aspect, the present invention provides a use of a biocidal fiber in textiles and the like as described herein.

Reference to the remaining portions of the specification, including the detailed description, will realize other features and advantages of the present invention.

### BRIEF DESCRIPTION OF THE DRAWINGS

FIG. 1A illustrates a reaction scheme of polypropylene with various monomers according to an embodiment of the present invention. FIG. 1B illustrates a reaction scheme of polypropylene with acrylamide in the presence of a radical initiator under a reactive extrusion conditions according to an embodiment of the present invention.

FIG. 2 illustrates exemplary cyclic and acyclic commercially available amine monomers used according to an embodiment of the present invention.

FIG. 3 illustrates an apparent melt viscosities of mixture of polypropylene with polymers formed by different monomers. Dicumyl peroxide (DCP) is used as an initiator with a concentration of 8.25 μmol per gram of polypropylene.

FIG. 4 illustrates apparent viscosities of polypropylene (PP)-graft-poly(methacrylamide) (MAM) polymers, with a monomer concentration of 0.5 mmol per gram of PP, a temperature of 190° C. and a dicumyl peroxide (DCP) initiator at different monomer to initiator ratios.

FIG. 5A illustrates FT-IR spectra of polypropylene-graft-poly(acrylamide) and polypropylene-graft-poly(methacrylamide) according to an embodiment of the present invention. FIG. 5B shows FT-IR spectra of polypropylene-graft-poly(N,N-diallymelamine) according to an embodiment of the present invention. FIG. 5C illustrates FT-IR spectra of several polypropylene-graft-poly(2,4-diamino-6-diallaylamino-1,3,5-triazine polymers prepared using different amount of monomers and initiators. FIG. 5D illustrates a comparison of FT-IR spectra of several graft copolymers PP-g-AAM, PP-g-MAM, PP-g-NTBA, PP-g-VBDMH and PP-g-ADMH with polypropylene (PP).

FIG. 6A illustrates active chlorine contents of some exemplary grafted fibers. FIG. 6B illustrates active chlorine content of grafted fibers having different fiber finesse.

FIG. 7 illustrates SEM micrographs of poly(N,N-diallymelamine)-g-PP fibers under different re-extrusion times: (a) once re-extrusion to gain 6.6 μm diameter lamellar fibers, (b) twice re-extrusion to gain 0.66 μm diameter finer fibers and (c) thrice re-extrusion to gain 0.51 μm diameter ultra-fine fibers.

FIG. 8 illustrates variation of active chlorine content with surface contact.

FIG. 9 illustrates a SEM graph of N,N-diallaylmelamine-g-PP fibers.

FIG. 10 illustrates the DSC profiles of grafted fibers.

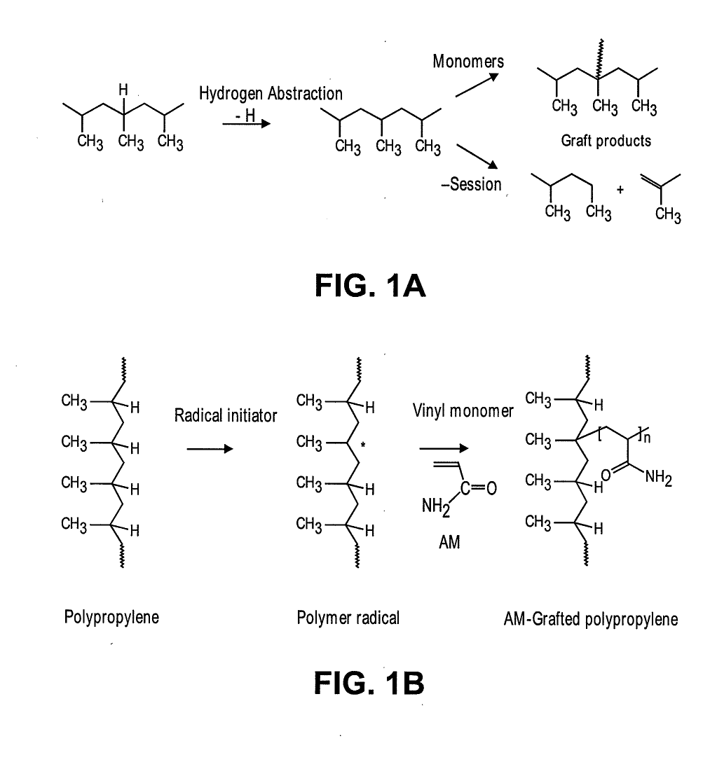

FIG. 1A illustrates the effect of DCP concentrations on grafting yield as a function of NDAM concentrations. FIG. 11B illustrates the effect of NDAM concentrations on grafting yield as a function of DCP concentrations.

FIG. 12A illustrates the effect of DCP concentrations on grafting yield as a function of NTBA concentrations. FIG. 12 B illustrates the effect of NTBA concentrations on grafting yield as a function of DCP concentrations.

FIG. 13 A illustrates the effect of St addition on grafting yield of NTBA as a function of DCP concentration, [NTBA]ᵢ=300 mpm, [St]ᵢ=300 mpm. FIG. 13 B illustrates the effect of initial concentration ratio of St to NTBA ([St]i/[NTBA]ᵢ) on grafting yield of NTBA, [DCP]ᵢ=4 mpm.

FIG. 14A illustrates the effect of NDAM and DCP concentration on active chlorine content. FIG. 14B illustrates the effect of initial concentration ratio of St to NTBA ([St]i/[NTBA]ᵢ) on chlorine content of PP-g-NTBA samples, [DCP]ᵢ=4 mpm.

### DETAILED DESCRIPTION OF THE INVENTION

The present invention is directed to graft biocidal N-halamine polymers and methods of making and using the graft biocidal N-halamine polymers. In particular, the biocidal polymers are N-halamine polyolefin-graft-poly(amine monomer) polymers, for example, N-halamine polypropylene-g-poly(acrylamide). The biocidal N-halamine graft polymers are synthesized by contacting precursor graft polymers with a halogen source. The precursor graft polymers can be synthesized, for example, during an extrusion process. The method has the advantage of combining the fiber spinning process and chemical modification into one step.

### I. Definitions

As used herein, the following terms have the meanings ascribed to them unless specified otherwise.

The term “poly(amine monomer)” as used herein includes polymers prepared by polymerizing a monomer containing an —NH₂ group or an —NH— moiety. For example, an amine monomer includes a substituted vinyl monomer of the formula: CH₂═C(R′)(R″), where R′ is hydrogen or an alkyl as defined herein and R″ is a substituent containing at least one —NH₂ or —NH— moiety.

The term “polyolefin” includes a polymer produced from a simple olefin or alkene as a monomer. For example, polyethylene and polypropylene. The term “poly-α-olefin” is a polymer made by polymerizing an alpha-olefin. An α-olefin is an alkene where the carbon-carbon double bond starts at the α-carbon atom. Non-limiting examples of α-olefin includes 2-alkylsubstituted ethylene, such as 2-methylpropene, 2-ethylbutene, 2-propylpentene, 2-butylhexene, 2-pentylheptene, 2-hexyloctene, and isomers thereof.

The term “alkyl”, by itself or as part of another substituent, includes, unless otherwise stated, a straight or branched chain hydrocarbon radical, having the number of carbon atoms designated (i.e. C₁₋₈ means one to eight carbons). Examples of alkyl groups include, but are not limited to methyl, ethyl, n-propyl, isopropyl, n-butyl, t-butyl, isobutyl, sec-butyl, n-pentyl, n-hexyl, n-heptyl, n-octyl, and the like. For each of the definitions herein (e.g., alkyl, alkoxy, haloalkyl), when a prefix is not included to indicate the number of main chain carbon atoms in an alkyl portion, the radical or portion thereof will have 12 or fewer main chain carbon atoms.

The term “alkylene” includes a saturated linear divalent hydrocarbon radical or a saturated branched divalent hydrocarbon radical containing from 1 to 20 carbon atoms. Preferably, the alkylene radical contains from 1 to 12 carbon atoms (i.e., C₁-C₁₂ alkylene). Exemplary alkylene groups include, but are not limited to, methylene, ethylene, propylene, butylene, pentylene, hexylene, heptylene, octylene, nonylene, decylene, undecylene, dodecylene, and the like.

The term “cycloalkyl” includes hydrocarbon rings having the indicated number of ring atoms (e.g., C₃₋₆cycloalkyl) and being fully saturated or having no more than one double bond between ring vertices. One or two carbon atoms may optionally be replaced by a carbonyl. Exemplary cycloalkyl groups include, but are not limited to, cyclopropyl, cyclobutyl, cyclopentyl, cyclohexyl, and the like.

The term “aryl” includes a monovalent monocyclic, bicyclic or polycyclic aromatic hydrocarbon radical of 5 to 10 ring atoms which is unsubstituted or substituted independently with one to four substituents, preferably one, two, or three substituents selected from alkyl, cycloalkyl, cycloalkyl-alkyl, halo, cyano, hydroxy, alkoxy, amino, acylamino, mono-alkylamino, di-alkylamino, haloalkyl, haloalkoxy, heteroalkyl, COR (where R is hydrogen, alkyl, cycloalkyl, cycloalkyl-alkyl, phenyl or phenylalkyl, aryl or arylalkyl), —(CR′R″)ₙ—COOR (where n is an integer from 0 to 5, R′ and R″ are independently hydrogen or alkyl, and R is hydrogen, alkyl, cycloalkyl, cycloalkylalkyl, phenyl or phenylalkyl aryl or arylalkyl) or —(CR′R″)ₙ—CONR′″R″″ (where n is an integer from 0 to 5, R′ and R″ are independently hydrogen or alkyl, and R′″ and R″″ are, independently of each other, hydrogen, alkyl, cycloalkyl, cycloalkylalkyl, phenyl or phenylalkyl, aryl or arylalkyl). More specifically the term aryl includes, but is not limited to, phenyl, biphenyl, 1-naphthyl, and 2-naphthyl, and the substituted forms thereof.

The term “heteroaryl” includes those aryl groups as defined herein wherein one to five heteroatoms or heteroatom functional groups have replaced a ring carbon, while retaining aromatic properties, e.g., pyridyl, quinolinyl, quinazolinyl, thienyl, and the like. The heteroatoms are selected from N, O, and S, wherein the nitrogen and sulfur atoms are optionally oxidized, and the nitrogen atom(s) are optionally quaternized. A heteroaryl group can be attached to the remainder of the molecule through a heteroatom. Non-limiting examples of heteroaryl groups include furyl, thienyl, pyridyl, pyrrolyl, oxazolyl), thiazolyl, imidazolyl, pyrazolyl, 2-pyrazolinyl, pyrazolidinyl, isoxazolyl, isothiazolyl, 1,2,3-oxadiazolyl, 1,2,3-triazolyl, 1,3,4-thiadiazolyl, pyridazinyl, pyrimidinyl, pyrazinyl, 1,3,5-triazinyl, 1,3,5-trithianyl, indolizinyl, indolyl, isoindolyl, 3H-indolyl, indolinyl, benzo [b]furanyl, 2,3-dihydrobenzofuranyl, benzo[b]thiophenyl, 1H-indazolyl, benzimidazolyl, benzthiazolyl, purinyl, 4H-quinolizinyl, quinolinyl, isoquinolinyl, cinnolinyl, phthalazinyl, quinazolinyl, quinoxalinyl, 1,8-naphthyridinyl, pteridinyl, carbazolyl, acridinyl, phenazinyl, phenothiazinyl, phenoxazinyl, and the like.

As used herein, the term “arylene” by itself or as part of another substituent includes a divalent radical derived from a polyunsaturated, typically aromatic, hydrocarbon group which can be a single ring or multiple rings (up to three rings) which are fused together or linked covalently. Optionally, the aromatic ring(s) can have one or more hetero atoms. Typically, an aryl (or arylene) group will have from 1 to 30 carbon atoms, with those groups having 12 or fewer carbon atoms being preferred in the present invention.

The above terms (“aryl” and “heteroaryl”), in some embodiments, will include both substituted and unsubstituted forms of the indicated radical. Preferred substituents for each type of radical are provided below. For brevity, the terms aryl and heteroaryl will refer to substituted or unsubstituted versions as provided below.

Substituents for the aryl and heteroaryl groups are varied and are generally selected from: -halogen, —OR′, —OC(O)R′, —NR′R″, —SR′, —R′, —CN, —NO₂, —CO₂R′, —CONR′R″, —C(O)R′, —OC(O)NR′R″, —NR″C(O)R′, —NR″C(O)₂R′, —NR′—C(O)NR″R′″, —NH—C(NH₂)═NH, —NR′C(NH₂)═NH, —NH—C(NH₂)═NR′, —S(O)R′, —S(O)₂R′, —S(O)₂NR′R″, —NR′S(O)₂R″, —N₃, perfluoro(C₁-C₄)alkoxy, and perfluoro(C₁-C₄)alkyl, in a number ranging from zero to the total number of open valences on the aromatic ring system; and where R′, R″ and R′″ are independently selected from hydrogen, C₁₋₈ alkyl, unsubstituted aryl and heteroaryl, (unsubstituted aryl)-C₁₋₄ alkyl, and unsubstituted aryloxy-C₁₋₄ alkyl. Other suitable substituents include each of the above aryl substituents attached to a ring atom by an alkylene tether of from 1-4 carbon atoms.

The term “alkoxy” includes an alkyl ether radical containing from 1 to 20 carbon atoms. Exemplary alkoxyl groups include, but are not limited to, methoxyl, ethoxyl, n-propoxyl, iso-propoxyl, n-butoxyl, iso-butoxyl, sec-butoxyl, tert-butoxyl, and the like.

The term “alkylamino” includes a mono- or di-alkyl-substituted amino radical (i.e., a radical having the formula: alkyl-NH— or (alkyl)₂—N—), wherein the term “alkyl” is as defined above. Exemplary alkylamino groups include, but are not limited to, methylamino, ethylamino, propylamino, iso-propylamino, t-butylamino, N,N-diethylamino, and the like.

The term “aminylene” includes a divalent amino radical (—NH—).

The term “alkylaminylene” refers to a divalent amino radical having the formula: alkyl(—N—), wherein the term “alkyl” is as defined herein.

The term “arylalkyl” includes an aryl radical, as defined herein, attached to an alkyl radical, as defined herein.

The term “heteroatom” includes any atom that is not carbon or hydrogen. Exemplary heteroatoms include, but are not limited to, nitrogen, oxygen, sulfur, phosphorus, boron, and the like.

The term “heteroalkyl” includes alkyl groups (or rings) that contain at least one heteroatom selected from N, O and S, for example, —N, —N—, —N═, —O, —O—, O═, —S—, —SO— and —S(O)₂—, wherein the nitrogen and sulfur atoms are optionally oxidized, and the nitrogen atom(s) are optionally quaternized. A heteroatom can form a double bond with a carbon atom.

The term “heteroalkylene” by itself or as part of another substituent includes a divalent radical derived from heteroalkyl, as exemplified, but not limited by, —CH₂CH₂OCH₂CH₂—, —CH₂SCH₂— and —CH₂NHCH₂—. For heteroalkylene groups, heteroatoms can also occupy either or both of the chain termini. Thus the term “heteroalkylene” includes bivalent alkoxy, thioalkyl, and aminoalkyl groups as defined herein.

The term “heteroarylene” includes the divalent radical group derived from heteroaryl (including substituted heteroaryl), as defined above, and is exemplified by the groups 2,6-pyridylene, 2,4-pyridiylene, 1,2-quinolinylene, 1,8-quinolinylene, 1,4-benzofuranylene, 2,5-pyridinylene, 2,5-indolenyl and the like.

The term “heterocycloalkyl” includes a cycloalkyl group that contain from one to five heteroatoms selected from N, O, and S, wherein the nitrogen and sulfur atoms are optionally oxidized, and the nitrogen atom(s) are optionally quaternized, the remaining ring atoms being C, where one or two C atoms may optionally be replaced by a carbonyl. The heterocycloalkyl may be a monocyclic, a bicyclic or a polycylic ring system. The heterocycloalkyl can also be a heterocyclic alkyl ring fused with an aryl or a heteroaryl ring. Non limiting examples of heterocycloalkyl groups include pyrrolidine, piperidiny, imidazolidine, pyrazolidine, butyrolactam, valerolactam, imidazolidinone, hydantoin, dioxolane, phthalimide, piperidine, 1,4-dioxane, morpholine, thiomorpholine, thiomorpholine-5-oxide, thiomorpholine-S,S-oxide, piperazine, pyran, pyridone, 3-pyrroline, thiopyran, pyrone, tetrahydrofuran, tetrahydrothiophene, quinuclidine, and the like. A heterocycloalkyl group can be attached to the remainder of the molecule through a ring carbon or a heteroatom.

The term “heterocyclyl” includes a saturated or unsaturated non-aromatic cyclic radical of 3 to 8 ring atoms in which one or two ring atoms are heteroatoms selected from O, NR (where R is independently hydrogen or alkyl) or S(O)ₙ (where n is an integer from 0 to 2), the remaining ring atoms being C, where one or two C atoms may optionally be replaced by a carbonyl group. The heterocyclyl ring may be optionally substituted independently with one, two, or three substituents selected from alkyl, cycloalkyl, cycloalkyl-alkyl, halo, nitro, cyano, hydroxy, alkoxy, amino, mono-alkylamino, di-alkylamino, haloalkyl, haloalkoxy, —COR (where R is hydrogen, alkyl, cycloalkyl, cycloalkyl-alkyl, phenyl or phenylalkyl), —(CR′R″)N—COOR (n is an integer from 0 to 5, R′ and R″ are independently hydrogen or alkyl, and R is hydrogen, alkyl, cycloalkyl, cycloalkyl-alkyl, phenyl or phenylalkyl), or —(CR′R″)ₙ—CONR^{x}R^{y} (where n is an integer from 0 to 5, R′ and R″ are independently hydrogen or alkyl, R^{x} and R^{y} are, independently of each other, hydrogen, alkyl, cycloalkyl, cycloalkylalkyl, phenyl or phenylalkyl). More specifically the term heterocyclyl includes, but is not limited to, tetrahydropyranyl, piperidino, N-methylpiperidin-3-yl, piperazino, N-methylpyrrolidin-3-yl, 3-pyrrolidino, 2-pyrrolidon-1-yl, morpholino, thiomorpholino, thiomorpholino-1-oxide, thiomorpholino-1,1-dioxide, pyrrolidinyl, and the derivatives thereof. The prefix indicating the number of carbon atoms (e.g., C₃-C₁₀) refers to the total number of carbon atoms in the portion of the cycloheteroalkyl or heterocyclyl group exclusive of the number of heteroatoms.

The term “heterocycloalkylalkyl” means a radical —R′R″ where R′ is an alkylene group and R″ is a heterocycloalkyl group as defined herein, e.g., tetrahydropyran-2-ylmethyl, 4-methylpiperazin-1-ylethyl, 3-piperidinylmethyl, and the like.

The term “halo” or “halogen” includes fluoro, chloro, bromo or iodo.

The term “amidyl” refers to R⁵¹C(O)N(R⁵⁷)—, wherein R⁵¹ and R⁵⁷ are each independently a hydrogen atom, an alkyl group, an aryl group, a cycloalkyl, a heteroalkyl, a heterocycloalkyl or a heteroaryl, as defined herein.

The term “treating,” “contacting,” or “reacting” includes adding or mixing two or more reagents under appropriate conditions to produce the indicated and/or the desired product. It should be appreciated that the reaction which produces the indicated and/or the desired product may not necessarily result directly from the combination of two reagents which were initially added, i.e., there may be one or more intermediates which are produced in the mixture which ultimately leads to the formation of the indicated and/or the desired product.

The terms “antimicrobial,” “microbicidal,” or “biocidal” include the ability to kill at least some types of microorganisms, or to inhibit the growth or reproduction of at least some types of microorganisms. The polymers prepared in accordance with the present invention have microbicidal activity (antimicrobial) against a broad spectrum of pathogenic microorganisms. For example, if the polymer is a textile, the textiles have microbicidal activity against representative gram-positive (such as Staphylococcus aureus) and gram-negative bacteria (such as Escherichia coli). Moreover, the microbicidal activity of such textiles is readily regenerable.

The term “fiber” as used herein includes a unit of matter, characterized by a length at least 100 times its diameter of width, which is capable of being spun into a yarn or made into a fabric by various methods such as weaving, knitting, braiding, felting and twisting.

The term “reactive extrusion” includes extrusion in which a multi-part polymer/resin blend is extruded and where polymerization occurs due to a chemical reaction. For example, the reactive extrusion process utilized a single screw extruder equipped with two static mixers. The initiator was injected into the extruder feedport and temperature programming used to cause most reaction to occur within the static mixers.

The term “N-halamines” includes a class of chemicals that contain a halogen bound to a nitrogen atom, where the nitrogen is a member of a ring, along with carbon atoms. When bound to the nitrogen, the halogen is in a stable form and retains the ability to interact with targets on the surfaces of bacteria and other microbes. The presence of the halogen renders it biocidal.

As used herein, the term “halogenating” or “halogenated” polymers include partially as well as fully halogenated. Preferred halogens are chlorine and bromine.

### II. General

The present invention provides a graft biocidal polymer. The graft biocidal polymer is prepared by halogenation of an amino and/or an aminylene (i.e. —NH—) containing precursor graft polymer. The amino and/or aminylene containing graft polymer is prepared by a grafting reaction of a polyolefin with a vinyl monomer containing at least one —NH₂ and/or —NH— moiety or functionality. For example, the reaction can be carried out in the presence of a free radical generating source, such as a free radical initiator under an extrusion condition. Sub-micro fibers are prepared by repeated extrusion processes. The graft biocidal polymers have a broad spectrum of antimicrobial activities. In particular, the sub-micro graft polymers demonstrate enhanced antimicrobial functions.

Halamine precursors can be easily grafted onto polypropylene through a reactive extrusion process and the grafted fibers can be readily converted to N-halamine structures upon exposure to commercially available halogenating source, such as chlorine bleach to produce halogenated polymer fibers. Monomers possessing higher reactivity with polymer radicals can be employed in the reactive extrusion process. The N-halamine derivatives of the grafted samples exhibited potent antimicrobial properties.

### III. Compounds

In one embodiment, the present invention provides graft polymers that can be used to form microbiocidal polymers. In other aspects, the polymers are readily converted to N-halamine structures on exposure to a halogen source such as commercially available chlorine bleach. The N-halamine derivatives of the corresponding grafted polymers exhibit potent antibacterial properties against microorganisms such as Escherichia coli, and these properties are durable and regenerable.

As such, in certain aspects, the present invention provides a polyolefin-graft-poly(amine monomer) polymer. The graft polymer includes a plurality of poly(amine monomer) side chains and a polyolefin main chain, wherein each of the plurality of side chains is linked to the main chain by a covalent bond. In some embodiments, each of the plurality of side chains is linked to the main chain through either —CH₂— or a tertiary carbon moiety. In one instance, the —CH₂— locates at the end of the side chains, and is used to connect to the main chain. The side chains can connect to the secondary carbons or the tertiary carbons of the main chain. Preferably, the side chains are connected to the tertiary carbons of the main chain.

In one embodiment, the graft polymer is a poly(α-olefin)-graft-poly(amine monomer). The poly(α-olefin) has a plurality of secondary and tertiary carbons and the side polymer chains are connected to at least one tertiary carbon of the main chain via covalent bonds. In some embodiments, all the side chains are connected to the main chains through the secondary carbons of the side chains. In certain other embodiments, the side chains are connected to the main chains through both secondary and the tertiary carbons of the side chains. In yet other embodiments, most of the side chains are connected to the main chain through the tertiary carbons of side chains and the tertiary carbons of the main chain to form a carbon-carbon single bond. In still yet other embodiments, all the side chains are connected through the tertiary carbons.

In one aspect, the present invention provides a polyolefin-graft-poly(amine monomer) polymer micro fiber having a diameter less than about 100, 90, 80, 70, 60, 50, 40, 30, 20, or 10 μm. The polymer fiber includes a polyolefin main chain and a plurality of poly(amine monomer) side chains, wherein each of the plurality of side chains is linked to the main chain through either —CH₂— or a tertiary carbon moiety of the side chains to form a covalent bond. The side chains can connect to either a secondary or a tertiary carbon, preferably the side chains are linked to a tertiary carbon on the main chain. In one embodiment, the polyolefin main chain has a structure of formula (I):

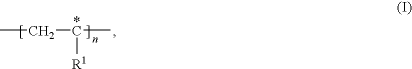

each the plurality of poly(amine monomer) side chains has a structure of formula (II):

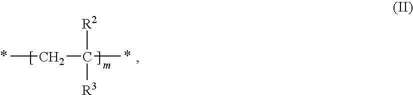

The asterisk symbols in formulas I and II represent points of attachment between the main chain and the side chains. In one embodiment, the side chains are attached through the —CH₂— end group.

In formula I, R¹ is selected from the group consisting of H, C₁₋₂₀alkyl, cycloalkyl-C₁₋₆alkyl, aryl, aryl-C₂₋₆-alkyl, heteroaryl, heteroaryl-C₂₋₆-alkyl and halide.

In a group of embodiments of the graft copolymer fibers, R¹ is —H, C₁₋₈alkyl, aryl, aryl-C₂₋₆alkyl. In certain instances, R¹ is —H, —CH₃, phenyl, phenylethyl or substituted phenyl and R² is —H. In certain other instances, the polyolefin main chain is a tactic polypropylene, such as an isotactic polypropylene or syndiotactic polypropylene.

The polyolefin main chain can also consist of a mixture, blend or copolymer of various polyolefins having different R¹ groups. For example, the polyolefin used in the present invention can be a mixture, a blend or a copolymer of polyethylene, polypropylene and polyvinyl chloride.

In formula II, R² is —H or C₁₋₈alkyl. In one embodiment, R¹ is —CH₃ and R² is —H or —CH₃.

In formula II, R³ is selected from the group consisting of —C(O)NH₂, —C(O)NHR^{a}, —NH₂C(O)R^{a}, —NHR^{a}C(O)R^{a}, —R^{b}, —OR^{b}, —R^{c}, R^{c}—C₁₋₆alkyl, R^{c}-aryl and R^{c}—C₁₋₆alkyl-aryl; wherein each R^{a} is independently C₁₋₈alkyl or aryl; R^{b} is selected from the group consisting of C₁₋₈alkyl, C₁₋₈haloalkyl, aryl, aryl-C₁₋₆alkyl, C₁₋₆alkylaryl, heterocycloalkyl, heterocycloalkyl-C₁₋₆alkyl, heterocycloalkyl-aryl, heterocycloalkyl-C₁₋₆alkyl-aryl, heteroaryl and heteroaryl-C₁₋₆alkyl, each of which is substituted with from 1-3 R⁵ substituents selected from the group consisting of —OC(O)NHR^{d}, —S(O)₂NHR^{d}, —NHS(O)₂R^{d}, —C(O)NHR^{d}, —NHC(O)R^{d}, —NHC(O)NH₂, —NR^{d}C(O)NH₂, —NR^{d}C(O)NHR^{d}, —NHC(O)NHR^{d}, —NHC(O)N(R^{d})₂, —NHCO₂R^{d}, —NH₂, —NHR^{d}, —NR^{d}S(O)NH₂, —NR^{d}S(O)₂NHR^{d}, —NH₂C(═NR^{d})NH₂, —N═C(NH₂)NH₂, —C(═NR^{d})NH₂, —NH—NHR^{d} and —NHC(O)NHNH₂, wherein each R^{d} is independently an C₁₋₈alkyl or aryl and R^{b} is optionally further substituted with from 1-3 members selected from the group consisting of C₁₋₆alkyl, halogen, NO₂ and CN; and R^{c} is heterocycloalkyl having at least one —NH— group as a ring member, optionally substituted with from 1-3 C₁₋₈alkyl substituents.

In one group of embodiments, R³ is —X¹C(O)NH₂, —X¹C(O)NHR₂, —X¹NH₂C(O)R^{a}, or —X¹NHR^{a}C(O)R^{a}, where R^{a} is C₁₋₈alkyl, phenyl or substituted phenyl and X¹ is —H or C₁₋₆alkyl. In certain instances, R³ is —C(O)NH₂, —C(O)NHR^{a}, —NH₂C(O)R^{a}, or —NHR^{a}C(O)R^{a}.

In another group of embodiments, R³ is C₃₋₈heterocycloalkyl or C₃₋₈heterocycloalkyl-C₁₋₁₆alkyl. In certain instances, R³ is selected from the group consisting of tetrahydropyranyl, tetrahydrothiophenyl, piperidino, piperazinyl, N-methylpiperidin-3-yl, piperazino, N-methylpyrrolidin-3-yl, 3-pyrrolidino, 2-pyrrolidon-1-yl, morpholino, thiomorpholino, thiomorpholino-1-oxide, thiomorpholino-1,1-dioxide, pyrrolidinyl, imidazolidinyl, 2-oxo-imidazolidinyl, pyrazolidinyl, oxazolidinyl, thiazolidinyl and isoxazolidinyl.

In yet another embodiment, R³ is selected from the group consisting of:

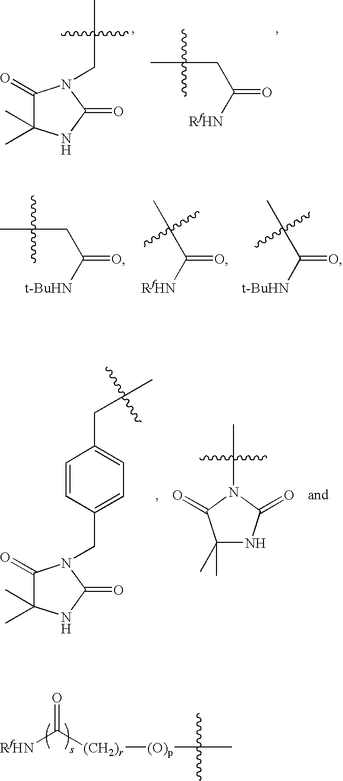

wherein each R^{f} is independently —H, C₁₋₆alkyl or aryl; r is an integer from 0 to 20; p is 0 or 1; and s is 0 or 1, with the proviso when s is 0, r is not 0. The —(CH₂)ᵣ— in formula R^{f}NHC(O)ₛ(CH₂)ᵣ(O)ₚ— is optionally substituted with from 1-2 substituents selected from C₁₋₈alkyl, aryl, halo, heteroaryl, —CN, —NO₂, hydroxyl, carboxyl or the like. In certain instances, s=0, p=1, R^{f} is —H or C₁₋₆alkyl, s is 0 and r is an integer from 1 to 20. In certain other instances, s=0, p=0, R^{f} is —H or C₁₋₆alkyl and r is an integer from 2-20. In still other instances, s=1, p=0, R^{f} is —H or C₁₋₆alkyl and r is an integer from 1 to 20. In yet other instances, s=1, p=1, R^{f} is —H or C₁₋₆alkyl and r is an integer from 0 to 20.

The subscript n is an integer from about 1 to about 20000, such as from 1-100, 100-1000, 100-20000, 1000-5000, 5000-10000, 10000-20000 and 1000-10000. In some embodiments, the polymers have a molecular weight greater than 20000.

The subscript m is an integer from about 1 to about 20000, such as 1-100, 100-500 and the like.

In another group of preferred embodiments, the poly(amine monomer) side chains have a structure selected from:

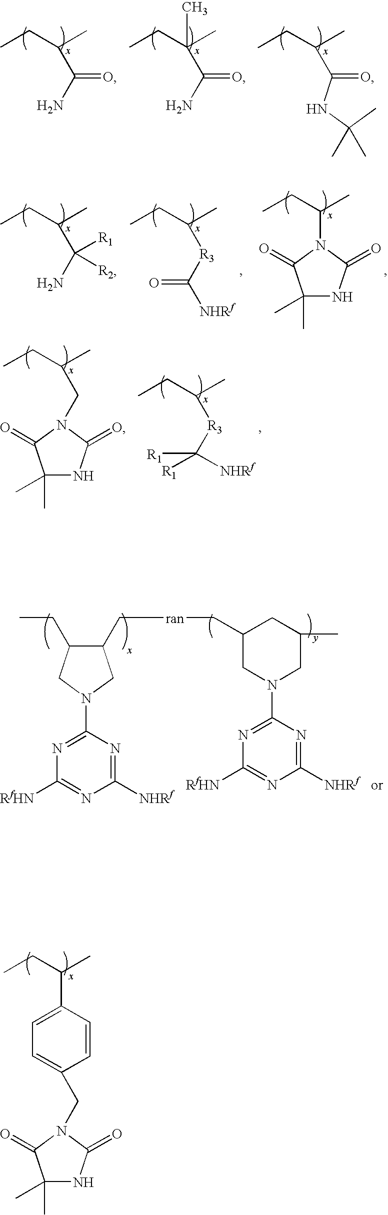

or a combination thereof, where R₁, R₂ are each independently a C₁₋₈alkyl, aryl, halo, heteroaryl, NO₂, hydroxyl, carboxyl or the like. R³ is a bond or C₁₋₆alkyklene. R^{f} is as defined above. In one embodiment, R^{f} is —H or C₁₋₆alkyl. Exemplary substituents include, but are not limited to, methyl, ethyl, propyl, butyl, phenyl, halo, NO₂ and the like. Each subscript x is independently an integer from 1-20000. Subscript y is an integer from 1-20000. Symbol “ran” stands for the copolymer formed is a random copolymer.

In one embodiment, the poly(amine monomer) is a polymer containing at least one aminylene or an amino moiety. The aminylene group can be in a linear structure or be part of a ring system. In a preferred embodiment, the poly(amine monomer) has formula IIA:

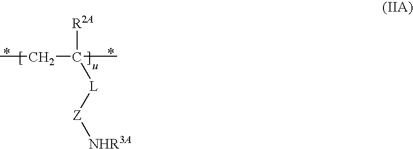

wherein R^{2A} is —H, C₁₋₆alkyl, aryl or halide; L is a member selected from the group consisting of a bond, an alkylene, a heteroalkylene, an arylene, aminylene, alkylaminylene and a heteroarylene; Z is a member selected from the group consisting of a bond, a heteroarylene and a heteroalkylene; and R^{3A} is —H, C₁₋₆alkyl or an aryl optionally substituted with an alkyl, heteroalkyl or a functional group, such as —OH, carboxyl, amino, halo, amidyl, carboxamido, carbamoyl, carbamoyl-oxy, ureido, alkoxy, alkylthio, hydroxycarbonyl or alkoxycarbonyl. The asterisk symbols represent points of attachment to the main chain. Preferably, the point of attachments is —CH₂-end group. The subscript u is an integer from about 1-20000, preferably from 100-20000.

In some preferred embodiments, R^{2A} is H or C₁₋₆alkyl, such as methyl, ethyl, propyl, butyl, pentyl, hexyl and the structural isomers thereof. L is C₁₋₆alkylene, C₁₋₆heteralkylene optionally interrupted with one or more heteratoms, or an arylene, for example, a phenylene optionally substituted with one or more functional groups. Z is a bond, a C₃₋₆heteroarylene or a substituted C₃₋₆heteroarylene. R^{3A} is —H or C₁₋₄alkyl, for example, methyl, ethyl, propyl or butyl.

In another embodiment, the poly(amine monomer) has a formula IIB:

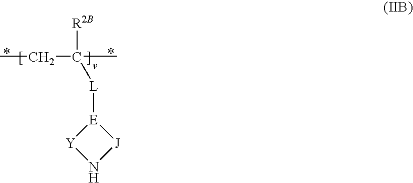

wherein R^{2B} is —H, C₁₋₆alkyl, aryl or halide; L is a member selected from the group consisting of a bond, an alkylene, a heteroalkylene, an arylene, aminylene, an alkylaminylene and a heteroarylene; E is a member selected from the group consisting of N, CH, SiH, CR^{a1} and SiR^{a1}, wherein R^{a1} is C₁₋₄alkyl; Y is a member selected from the group consisting of a heteroatom, an alkylene and a heteroalkylene; and J is a member selected from the group consisting of a bond, a heteroatom, an alkylene and a heteroalkylene. Preferably, the point of attachments is —CH₂-end group. The subscript v is an integer from about 1-20000.

In a group of embodiments, L is a bond or C₁₋₄alkylene; E is —N═, —CH═ or —CR^{a}═, wherein R^{a1} is C₁₋₄alkyl. Y is C₁₋₄heteroalkylene or C₁₋₄alkylene; and J is a bond, a heteroatom, such as N, O or S, C₁₋₄heteroalkylene or C₁₋₄alkylene.

In another aspect, the present invention provides a polyolefin-graft-poly(amine monomer) polymer fiber comprising a polyolefin main chain and a plurality of poly(amine monomer) side chains, wherein each of the plurality of side chains is linked to the main chain through either a —CH₂— or a tertiary carbon moiety of the side chains to form a covalent bond. The side chains can connect to either a secondary or a tertiary carbon on the main chain. The polyolefin main chain has a structure of formula (I):

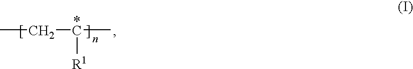

each plurality of poly(amine monomer) side chains is a sequence of q structure repeat unit independently selected from the group consisting of:

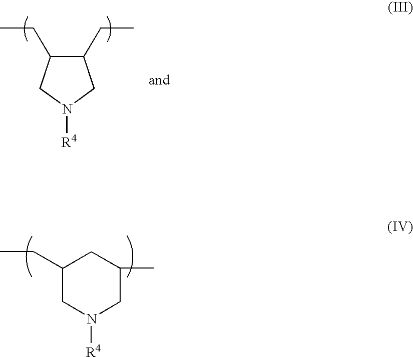

In one embodiment, the poly(amine monomer) side chain of the graft polymer fiber is a sequence of q structure repeat unit having the formula:

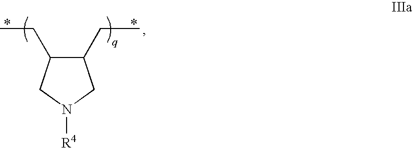

each of the adjacent structure repeat units is joined together through a carbon-carbon single bond to form a sequence of q structure repeat units. In another embodiment, the poly(amine monomer) side chain of the graft polymer fiber is a sequence of q structure repeat unit having the formula:

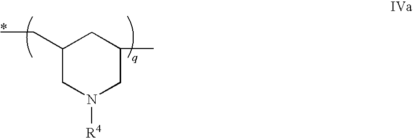

The structure repeat units of formula III and IV can exist in the poly(amine monomer) side chains at various ratios, for example, from about 1% to about 99%, respectively. Exemplary ratios of repeat units of formula III include, 5, 10, 15, 20, 25, 30, 35, 40, 45, 50, 55, 60, 65, 70, 75, 80, 85, 90 and 95%. Some polymer side chains contain 100% repeat units of formula III. Some other polymer side chains contain 100% repeat units of formula IVa.

R¹ is as defined above.

R⁴ is aryl-C₁₋₆alkyl, aryl, heteroaryl or heteroaryl-C₁₋₆alkyl, each of which is substituted with from 1-3 R⁷ substituents selected from the group consisting of —OC(O)NHR^{e}, —S(O)₂NHR^{e}, —NHS(O)₂R^{e}, —C(O)NHR^{e}, —NHC(O)R^{e}, —NHC(O)NH₂, —NR^{e}C(O)NH₂, —NR^{e}C(O)NHR^{e}, —NHC(O)NHR^{e}, —NHC(O)N(R^{e})₂, —NHCO₂R^{e}, —NH₂, —NHR^{e}, —NR^{e}S(O)NH₂, —NR^{e}S(O)₂NHR^{e}, —NH₂C(═NR^{e})NH₂, —N═C(NH₂)NH₂, —C(═NR^{e})NH₂, —NH—NHR^{e} and —NHC(O)NHNH₂, wherein each R^{e} is independently an C₁₋₈alkyl or aryl and R⁴ is optionally further substituted with from 1-3 C₁₋₆alkyl substituents.

In a group of embodiments, R⁴ is selected from phenyl, substituted phenyl, substituted phenyl-C₁₋₆alkyl, heteroaryl and heteroaryl-C₁₋₆alkyl, each of which is substituted with from 1-3 R⁷ substituents. The heteroaryl includes both substituted and unsubstituted heteroaryl. In certain instances, the heteroaryl is selected from the group consisting of furyl, thienyl, pyridyl, pyrrolyl, oxazolyl), thiazolyl, imidazolyl, pyrazolyl, 2-pyrazolinyl, pyrazolidinyl, isoxazolyl, isothiazolyl, 1,2,3-oxadiazolyl, 1,2,3-triazolyl, 1,3,4-thiadiazolyl, pyridazinyl, pyrimidinyl, pyrazinyl, 1,3,5-triazinyl, 1,3,5-trithianyl, indolizinyl, indolyl, isoindolyl, 3H-indolyl, indolinyl, benzo[b]furanyl, 2,3-dihydrobenzofuranyl, benzo[b]thiophenyl, 1H-indazolyl, benzimidazolyl, benzthiazolyl, purinyl, 4H-quinolizinyl, quinolinyl, isoquinolinyl, cinnolinyl, phthalazinyl, quinazolinyl, quinoxalinyl, 1,8-naphthyridinyl, pteridinyl, carbazolyl, acridinyl, phenazinyl, phenothiazinyl, phenoxazinyl, and the like. In one instance, R⁴ is 2,4-diamino-triazin-6-yl.

Subscripts n and m are as defined above. Symbol q is an integer from 1 to about 20000, for example, from 1-100, 1-1000, 100-500, 500-2000 and the like.

In yet another aspect, the present invention provides a biocidal polyolefin-graft-poly(amine monomer) polymer comprising a polyolefin main chain and a plurality of poly(amine monomer) side chains, wherein each of the plurality of side chains is linked to either a secondary or a tertiary carbon on the main chain through either a —CH₂— or a tertiary carbon moiety at the end of the side chains to form a carbon-carbon single bond and wherein each of the side chains comprises at least one member selected from the group consisting of —N(X)— and —NHX, wherein X is selected from the group consisting of —F, —Cl, —Br and —I. In one embodiment, X is —Cl.

In one embodiment of the biocidal polymer, the polyolefin main chain has a plurality of secondary and tertiary carbons, wherein at least one covalent bond is formed between the —CH₂— of the plurality of side chains and a tertiary carbon of the main chain. In another embodiment, each of the plurality of side chains is independently linked to either a secondary or a tertiary carbon on the main chain through —CH₂— group of the side chains. In certain instances, about 10, 20, 30, 45, 50, 60, 65, 70, 80, 85, 90, 95 or 99% of the side chains are linked to the tertiary carbon of the main chains and the rest are linked through a secondary carbon on the main chain. In certain other instances, about 10, 20, 30, 45, 50, 60, 65, 70, 80, 85, 90, 95 or 99% of the side chains are linked to the main chains through —CH₂— linkage at the end of the side chains. In one instance, each of the side chains is linked to the main chain through the —CH₂— linkage of the side chains and the tertiary carbon of the main chain to form a carbon-carbon single bond.

In one embodiment, the polyolefin main chain of the biocidal polymer comprises a structure of formula I:

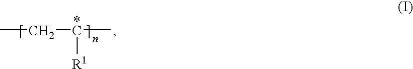

where R¹ is as defined above. In certain instances, R¹ is C₁₋₆alkyl. In certain other instances, R¹ is —CH₃.

In one embodiment, the poly(amine monomer) side chains of the biocidal polymer fiber have a structure of formula (II):

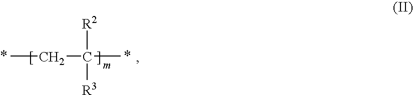

where substituents R², R³, R^{a}, R^{b}, R^{c}, R⁵ and subscript m are as defined above. In certain instances, R² is —H or —CH₃ and R³ is —C(O)NH₂, —C(O)NHR^{a}, —NH₂C(O)R^{a}, —NHR^{a}C(O)R^{a}, heterocycloalkyl-C₁₋₆alkyl, heterocycloalkyl-C₁₋₆alkyl-aryl and —X¹—R⁵, wherein the heterocycloalkyl has at least one —NH— group as a ring member and —X¹— is a C₁₋₆alkylene, optionally substituted with from 1-3 members selected from the group consisting of C₁₋₆alkyl, halogen, —NO₂, —OH, alkoxy, alkoxycarbonyl, carboxyl, —COOH and —CN. In one occurrence, R^{a} is C₁₋₆alkyl, phenyl or substituted phenyl. Preferably, the side chains are linked to the main chain through the —CH₂— end group of the side chains.

In another embodiment, the poly(amine monomer) side chain of the biocidal polymer fiber is a sequence of q structure repeat units independently selected from the group consisting of:

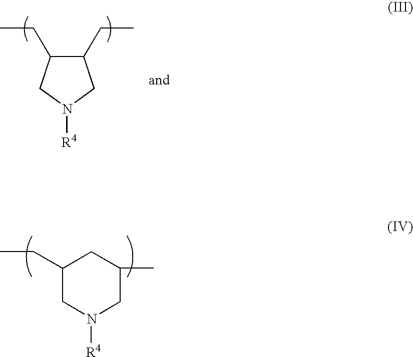

The structure repeat units are joined together through carbon-carbon single bonds. The substituents R⁴, R^{e} and symbol q are as defined above. In one instance, the poly(amine monomer) side chain of the biocidal polymer fiber is a sequence of q structure repeat unit having formula IIIa. In another instance, the poly(amine monomer) side chain of the biocidal polymer fiber is a sequence of q structure repeat unit having the formula IVa. In certain instances, R⁴ is a heteroaryl substituted with two —NH₂ or —NH—C₁₋₆alkyl groups. For example, R⁴ is 2,4-diamino-1,3,5-triazin-6-yl.

### IV. Synthesis

In one aspect, the present invention provides a method for preparing a precursor graft polymer, such as polyolefin-graft-poly(amine monomer) polymer fiber. The method includes admixing a polymer, such as polyolefin fiber with a vinyl monomer in the presence or absence of a free radical generating source or initiator or generator under conditions sufficient to form a graft fiber.

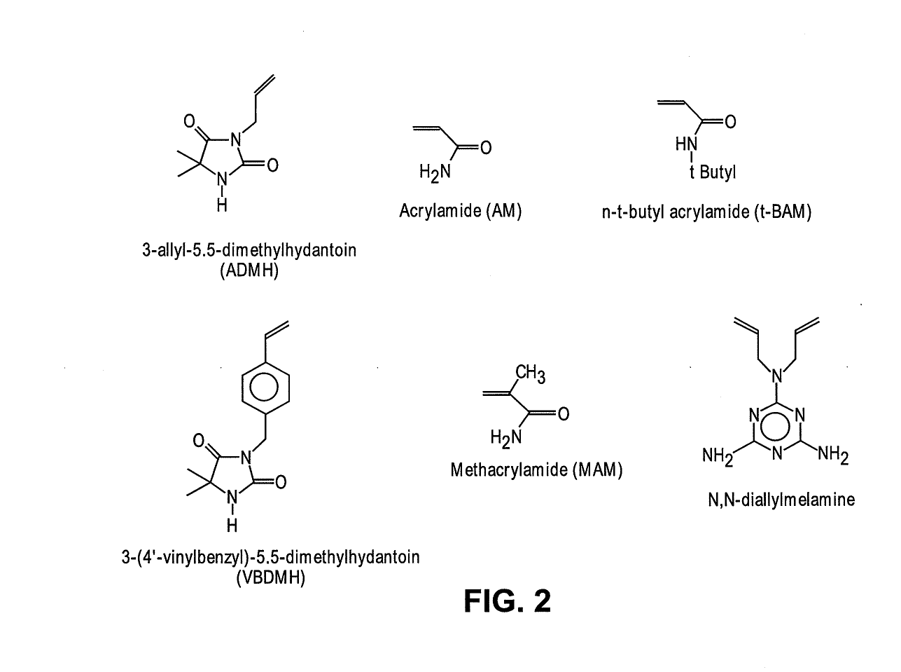

In another aspect, the present invention provides a method for preparing a polyolefin-graft-poly(amine monomer) biocidal fiber. The method includes admixing a polyolefin fiber, a vinyl monomer having one or more —NH— or —NH₂ groups and a free radical initiator in an extruder under conditions sufficient to form a graft polymer, extruding the graft polymer to produce a graft polymer fiber, and contacting the graft polymer fiber with a halogen generating source under conditions sufficient to form a biocidal fiber containing one or more —N(X)— and —NHX groups, wherein X is selected from the group consisting of —F, —Cl, —Br and —I. FIG. 2 shows several commercially available monomers as can be used to form the graft copolymers with polyolefins, such as polypropylene.

The monomers are either commercially available or readily prepared using known starting materials or intermediates. Terminal olefins are readily constructed from a precursor aldehydes or ketones using Wittig reaction (see, Maercker et al. Org. React. 1965, 14, 270; and Maryanoff et al, Chem. Rev. 1989, 89, 863) or Metathesis reactions (Grubbs Hand Book of Mathesis, Wiley, 2003), which are generally known to a person of skill in the art. Scheme 1 sets forth an exemplary synthetic scheme for the preparation of certain monomers used in present invention.

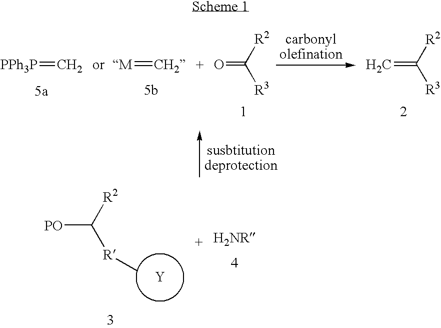

In scheme 1, precursor compound 3 has a group Y, which is capable of reacting with an amine or an amide functionality. P is a hydroxyl or carbonyl protecting group. Exemplary Y groups include halides, tosylates, mesylates, sulfonate esters, carboxylic acid esters, anhydrides, aldehydes and ketones. Subsequent reaction of compound 3 with amino containing compound 4 through an amination or substitution reaction, followed by removing of the protecting group yields compound 1. When compound 4 is an amine and Y is attached to an alkyl or a carbonyl, a basic reagent, such as pyridine or triethylamine is used in the reaction. When Y is a halide attached to an aromatic ring, a transition metal mediated amination reaction is utilized to form a carbon-nitrogen bond (see, Riermeier, et al. “Palladium-catalyzed C—C- and C—N-coupling reactions of aryl chlorides” in Topics in Catalysis, Springer, 2004; King, et al. “Palladium-Catalyzed Cross-Coupling Reactions in the Synthesis of Pharmaceutical” in Topics in Organometallic Chemistry, Springer, 2004). Examples of amination catalysts include Pd(PPh₃)₄, Pd(OAc)₂ and the like. When compound 4 is an amide and Y is attached to an alkyl or a carbonyl, a base such as NaH, KOH or lithium diisopropylamide is used in the reaction. Compound 1 is reacted with a Wittig reagent 5a or a metal carbine complex 5b to yield monomer 2. The choice of these and other leaving groups appropriate for a particular set of reaction conditions is within the abilities of those of skill in the art (see, for example, March J, Advanced Organic Chemistry, 6th Edition, Wiley, 2007; Sandler S R, Karo W, Organic Functional Group Preparations, 2nd Edition, Academic Press, Inc., 1986; Wade L G, Compendium of Organic Synthetic Methods, John Wiley and Sons, 1980; and Larock, R. Comprehensive Organic Transformations: A Guide to Functional Group Preparations; 2nd ed., Wiley, 2000)). The choice of the appropriate hydroxyl or carbonyl protecting groups and detailed reaction conditions is within the abilities of those skilled in the art (see, Greene, et al. Protective Group in Organic Synthesis, Wiley, 4th ed, 2006). The monomers prepared can be purified using conventional techniques and characterized by Nuclear Magnetic Resonance spectroscopy (NMR), FT-IR and mass spectroscopy. Purification techniques generally known to those skilled in the art include crystallization, distillation, flash chromatography, gas chromatography, size exclusion chromatography and the like.

Various vinyl monomers of the formula: CH₂═CR²R³ can be used for the preparation of the side chain poly(amine monomer) of polyolefin-graft-pol(amine monomer), wherein R² is —H or C₁₋₈alkyl, and R³ are substituents containing an aminylene or an amino moiety. In a group of embodiments, the vinyl monomers have a formula selected from:

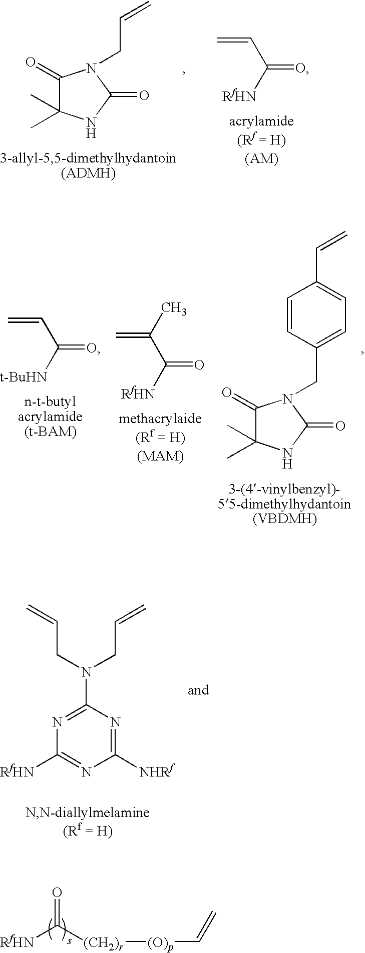

where each R^{f} is independently —H, C₁₋₈alkyl or aryl. The subscript r is an integer from 0 to 20. The subscript p is 0 or 1. The subscript s is 0 or 1, with the proviso when s is 0, r is not 0. Optionally, the aliphatic —(CH₂)ᵣ— moiety in formula R^{f}NHC(O)(CH₂)ᵣ(O)ₚCHCH₂ is substituted with from 1-2 members selected from C₁₋₈alkyl, aryl, halo, heteroaryl, —CN, —NO₂, hydroxyl, carboxyl and the like. In one embodiment, R^{f} is —H.

Various methods known in the art can be used for the preparation of a polyolefin. Typically, the polymers are synthesized by polymerizing a vinyl monomer in the presence of an initiator. The initiator can be a radical initiator, an ionic initiator, an organic salt, an inorganic salt, an organometallic or a metal catalyst (see, Braun, D. et al “Polymer Synthesis: Theory and Practice: Fundamentals, Methods and Experiments” 4th Ed. Springer, 2004 and references therein). A person of ordinary skill in the art will recognize that copolymers can be synthesized by polymerizing a mixture of different vinyl monomers.

In one embodiment, the present invention provides a method for preparing a poly(α-olefin)-graft-poly(amine monomer) polymer. The method includes admixing a poly(α-olefin) fiber of formula V:

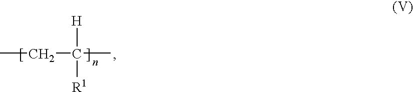

a monomer having formula VI or VII:

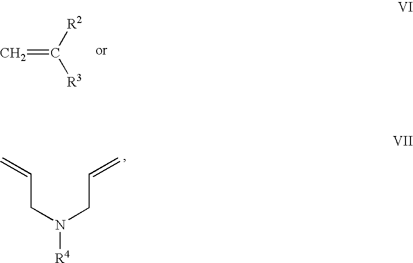

and a free radical generator under conditions sufficient to form a graft polymer; and extruding the product to produce a graft polymer fiber.

R¹ is —H or C₁₋₆alkyl. R² is —H or C₁₋₈alkyl. R³ is selected from the group consisting of: —C(O)NH₂, —C(O)NHR^{a}, —NH₂C(O)R^{a}, —NHR^{a}C(O)R^{a}, —R^{b}, —OR^{b}, —R^{c}, R^{c}—C₁₋₆alkyl, R^{c}-aryl and R^{c}—C₁₋₆alkyl-aryl; wherein each R^{a} is independently C₁₋₈alkyl or aryl; R^{b} is selected from the group consisting of C₁₋₈alkyl, C₁₋₈haloalkyl, aryl, aryl-C₁₋₆alkyl, C₁₋₆alkylaryl, heterocycloalkyl, heterocycloalkyl-C₁₋₆alkyl, heterocycloalkyl-aryl, heterocycloalkyl-C₁₋₆alkyl-aryl, heteroaryl and heteroaryl-C₁₋₆alkyl, each of which is substituted with from 1-3 members selected from the group consisting of —OC(O)NHR^{d}, —S(O)₂NHR^{d}, —NHS(O)₂R^{d}, —C(O)NHR^{d}, —NHC(O)R^{d}, —NHC(O)NH₂, —NR dC(O)NH₂, —NR^{d}C(O)NHR^{d}, —NHC(O)NHR^{d}, —NHC(O)N(R^{d})₂, —NHCO₂R^{d}, —NH₂, —NHR^{d}, —N(R^{d})₂, —NR^{d}S(O)NH₂, —NR^{d}S(O)₂NHR^{d}, —NH₂C(═NR^{d})NH₂, —N═C(NH₂)NH₂, —C(═NR^{d})NH₂, —NH—NHR^{d} and —NHC(O)NHNH₂, wherein each R^{d} is independently an C₁₋₈alkyl or aryl and R^{b} is optionally further substituted with from 1-3 members selected from the group consisting of C₁₋₆alkyl, halogen, NO₂ and CN; R^{c} is heterocycloalkyl having at least one —NH— group as a ring member, optionally substituted with from 1-3 C₁₋₈alkyl substituents; and R⁴ is aryl-C₁₋₆alkyl, C₁₋₆alkylaryl, aryl, heteroaryl and heteroaryl-C₁₋₆alkyl, each of which is substituted with from 1-3 R⁵ substituents; and R⁶ is —H or C₁₋₄alkyl.

In one embodiment, the method further includes purifying the graft polymer fiber. The purification includes repetitive precipitation, filtration, washing with an organic solvent and drying at an elevated temperature or in vacuum.

The present invention uses a reactive extrusion process, which utilized a single screw extruder equipped with two static mixers. The initiator was injected into the extruder feedport and temperature programming used to cause most reaction to occur within the static mixers.

The process to produce this improved impact propylene copolymer involves coupling of the impact propylene copolymer using a coupling agent. The coupling reaction is implemented via reactive extrusion or any other method which is capable of mixing the coupling agent with the impact propylene copolymer and adding sufficient energy to cause a coupling reaction between the coupling agent and the impact propylene copolymer. In one embodiment, the process is carried out in a single vessel such as a melt mixer or a polymer extruder, such as described in U.S. patent application Ser. No. 09/133,576 filed Aug. 13, 1998, which claims the benefit of U.S. Provisional Application No. 60/057,713 filed Aug. 27, 1997, both of which are incorporated by reference herein in their entity. The term extruder is intended to include its broadest meaning and includes such devices as a device which extrudes pellets as well as an extruder which produces the extrudate for forming into films, blow molded articles, profile and sheet extruded articles, foams and other articles.

In certain aspects, the present invention provides a graft polymer as defined above. FIGS. 1A-1B illustrate an example of the synthesis of a graft polymer. FIGS. 1A-1B are merely examples that should not limit the scope of the claims herein. One of ordinary skill in the art will recognize many other variations, alternatives, and modifications. As shown, a polypropylene is reacted with an acrylamide in the presence of a free radical initiator to yield a graft polymer.

FIG. 1A shows a controlled graft reaction during reactive extrusion according to an embodiment of the present invention. For example, polypropylene can be extruded into fibers in a temperature range of 180-240° C. depending on its melting point. Polypropylene pellets or powder, together with reactive monomers and radical initiators, is fed into a twin extruder. The chemical modification of polypropylene during the extrusion uses a controlled radical graft polymerization reaction. Radical initiators will first decompose to initiator radicals, and the initiator radical will abstract an active hydrogen, mostly tertiary hydrogen atoms, from polypropylene to produce polymer radicals. The polymer radicals will then react with monomers to complete the graft polymerization reaction. The initiators will produce radicals that can preferably abstract hydrogen from polymer chains instead of adding to functional monomers, which provide the required control. The selected radical initiators and monomers are stable and can effectively react under the temperature range. The most often cited side reaction is degradation caused by the initially formed radical undergoing β-scission. This process decreases viscosity of polymer melts significantly.

The graft polymers can be prepared by chemical modification. The chemical modification includes grafting the monomers alone, or as a copolymer onto existing natural or synthetic polymers in the presence of at least one other existing vinyl monomer. The polymerization and chemical modification reactions can be initiated by a thermal or radiation method, or the combinations thereof, optionally in the presence of initiators. The resultant grafted polymers can be used as plastics, rubbers, polymeric materials, paints, surface coatings, adhesives, etc., in the form of bulk, films/membranes, powder, solutions, gels, and the like.

Various polymers can be chemically modified using the methods of the present invention. Polymers suitable for use in the present invention include, but are not limited to, a plastic, a rubber, a textile material, a paint, a surface coating, an adhesives, cellulose, a polyester, wood pulp, paper and a polyester/cellulose blend. The polymeric materials suitable for the present invention include, but are not limited to, naturally occurring fibers from plants, such as cellulose, cotton, linin, hemp, jute and ramie. They include polymers from animals, based upon proteins and include, but are not limited to, wool, mohair, vicuna and silk. Textiles also include manufactured fibers based upon natural organic polymers such as, rayon, lyocell, acetate, triacetate and azlon. Textiles suitable for use in the present invention include synthetic organic polymers which include, but are not limited to, acrylic, aramid, nylon, olefin, polyester, spandex, vinyon, vinyl and graphite. Textiles also include inorganic substances such as glass, metallic and ceramic.

Various textiles are preferred to practice the invention. These include, but are not limited to, a fiber, a yarn or a natural or synthetic fabric. Various fabrics include, but are not limited to, a nylon fabric, a polyester, an acrylic fabric, NOMEX®, a triacetate, an acetate, a cotton, a wool and mixtures thereof NOMEX® is made of an aromatic polyamide material and is available from DuPont (Wilmington, Del.) NOMEX® is used in fire fighting equipment.

The polymeric plastics suitable for the present invention include thermoplastic or thermosetting resins. The thermoplastics include, but are not limited to, polyethylene, polypropylene, polystyrene, and polyvinylchloride. Thermoplastics also include, polyamideimide, polyethersulfone, polyarylsulfone, polyetherimide, polyarylate, polysulfone, polycarbonate and polystyrene. Additional thermoplastics include, but are not limited to, polyetherketone, polyetheretherketone, polytetrafluoroethylene, nylon-6,6, nylon-6,12, nylon-11, nylon-12, acetal resin, polypropylene, and high and low density polyethylene.

The polymerization and chemical modification reactions can proceed by various polymerization techniques well known by those of skill in the art. For example, a free radical initiation method, a photoinitiated method, thermal initiated method or a metal or organometallic catalysts mediated process are all suitable methods. In one embodiment, a polymer, such as a polyolefin of formula V can be grafted with a vinyl monomer by a free radical initiation method, such as by dissolving all desired monomers in a solvent, such as N,N-dimethylacetamide or other suitable solvent and adding, under, for example, nitrogen atmosphere, an initiator, such as benzoyol peroxide, azobisisobutyronitrile or cumyl peroxide and allowing the mixture to react, at an elevated temperature for the solvent, to produce the graft polymer. Some preferred monomers for grafting polymerization is shown in FIG. 2. Other monomers that can be grafted with a polymer of formula V include, but are not limited to, acrylonitrile, styrene, methacrylamide, methyl-methacrylate, ethylene, propylene, butylenes, butadienes and other alkenes and dienes. The resulting unhalogenated polymers or copolymers can then be halogenated, with free halogen, such as chlorine and bromine sources, as described herein.

In certain aspects, the polymer of formula V alone, or together, can be grafted with at least one other existing vinyl monomer, with or without the addition of free radical initiators, in bulk, aqueous solution or suspension, organic solvents, or emulsions. The resultant polymers can thereafter be used as plastics, rubbers, polymeric materials, paints, surface coatings, adhesives, etc, in the form of bulk, films/membranes, powder, solutions, gels, etc.

As such, in another embodiment, the present invention provides a polyolefin polymer comprising a mixture of monomer units having the formula V. In this embodiment, a polymer of formula V and a vinyl monomer, such as an acrylic monomer, a monofunctional vinyl monomer, a polyfunctional vinyl monomer and mixtures thereof, are reacted together to form copolymers. Examples of such vinyl monomers include, but are not limited to, acrylonitrile, amino or amide substituted styrene, acrylamide, methacrylamide, amino or amide substituted alkenes and dienes, such as 2-amino-C₁₋₈alkylethylene or 2-C₁₋₄alkylamino-C₁₋₈alkylethylene, 2-amino-C₁₋₈alkylbutadiene, 4-amino-C₁₋₈alkylbutadiene, 2-C₁₋₄alkylamino-C₁₋₈alkylbutadiene, 4-C₁₋₄alkylamino-C₁₋₈alkylbutadiene. The copolymers thus formed have a least one dimeric unit consisting of at least two different monomer repeat units.

In yet another embodiment, the compounds of formula VI and/or VII alone, or together, in the presence of a polyolefin, can be polymerized with optionally at least one other existing vinyl monomer, with or without the addition of free radical initiators, in bulk, aqueous solution or suspension, organic solvents, or emulsions to form the side chains of graft polymers.

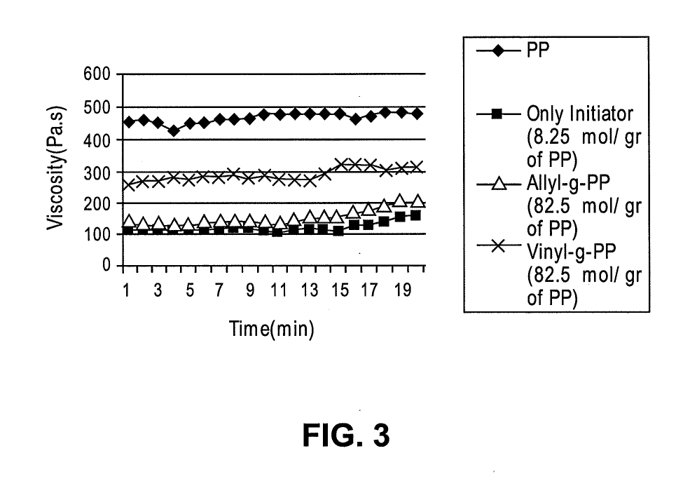

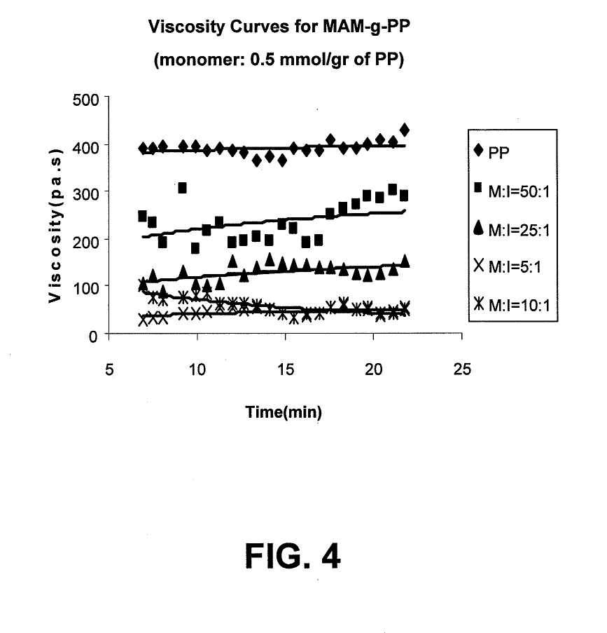

In the radical initiated grafting reactions, 3-allyl-5,5-dimethylhydrantoin (ADMH) can be used. The peroxide initiator was proven quite effective in producing polymer radicals, but the polymer radicals are preferably dispatched quickly. ADMH can react with the polymer radicals, but may lead to lower melt viscosity (FIG. 3). Higher reaction rates result in higher viscosities (FIG. 3). In addition, the ratio of monomer to peroxide initiator can affect β-session reactions as well as homopolymerization of monomers (FIG. 4).

Various free radical generators can be used for the preparation of poly(amine monomer)-g-polyolefin polymer. Suitable free radical initiators can be found in Denisov et al. Hand Book of Free Radical Initiators, Wiley, 2003. In general, the free radical initiators are commercially available and include diazo compounds, peroxide compounds and redox transition metal salts. Non-limiting examples of initiators include azobisisobutyronitrile (AIBN) and azobiscyclohexanecarbonitrile, benzoyl peroxide, di-t(tertiary)-butylhttp://en.wikipedia.org/wiki/Butylperoxide, cumyl peroxide, acetyl peroxide. t-butyl perbenzoate, acyl alkylsulfonyl peroxide, diperoxyketals, Fe²⁺/H₂O₂, Fe²⁺/S₂O₈²⁻ and Ce⁴⁺/alcohol. The polymerizations can be initiated either thermally or photochemically. Preferably, the initiators does not decompose below the reaction temperature, such as the extrusion temperature. The initiators are chosen such that the free radicals generated preferentially react with the polymer chain to generate a polymer radicals, which further react with added monomers to form graft polymers.

The present invention provides a method for preparing a biocidal fiber. The method includes admixing a polyolefin fiber of formula V with a monomer having formulas VI or VII under conditions sufficient to form a graft fiber, and contacting the graft fiber with a halogen generating source to form a biocidal fiber. In one embodiment, the polymerization requires an initiator. In another embodiment, the polymerization can be carried out in the absence of an initiator. The graft polymer can be formed at an ambient temperature or an elevated temperature in bulk or in solution phase, in the presence or absence of an initiator, catalyst or a second reagent. The graft polymer can also be formed either photochemically or under a redox condition.

Once formed, the graft polymers can be made biocidal by reacting the corresponding unhalogenated polymers, with a halogen source. Suitable halogenating agents such as calcium hypochlorite, sodium hypochlorite (e.g., CLOROX®), N-chlorosuccinimide, N-bromosuccinimide, sodium dichloroisocyanurate, trichloroisocyanuric acid, tertiary butyl hypochlorite, N-chloroacetamide, N-chloramines, N-bromamines, etc., can be used.

The halogenation of the unhalogenated polymers can be accomplished in aqueous media or in mixtures of water with common inert organic solvents such as methylene chloride, chloroform, and carbon tetrachloride, or in inert organic solvents themselves, at room temperature. Those of skill in the art will know of other solvents or solvent mixtures suitable for use in the present invention. In certain instances, the unhalogenated polymers can be a previously-utilized cyclic N-halamine polymer that needs to be regenerated due to inactivation of the N-halamine moieties.

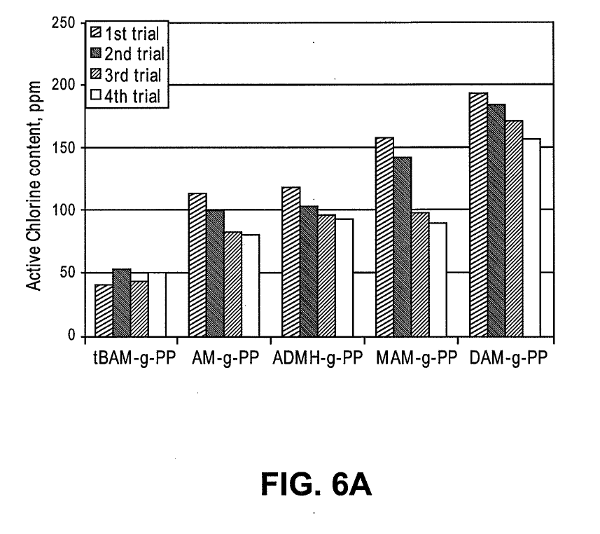

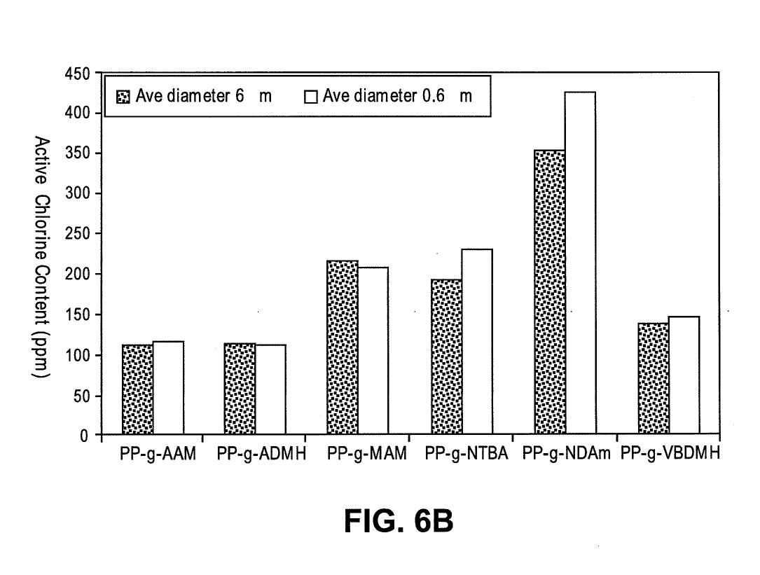

In one embodiment, in order to produce biocidal fibers, halamine-incorporated fibers activated through immersing in chlorine bleach solution. Volumetric titration was used to evaluate active chlorine contents of the grafted fibers after reduction with sodium thiosulfate solutions, FIGS. 6A and 6B show the active chlorine data for all grafted polypropylene fibers for several trials. N-halamine chemistry can be expressed in equations 1 and 2. When N-halamine structures are exposed to water, the reaction shown in equation 1 may occur. The equilibrium in equation 1 may shift toward either reactants or products depending on the N-halamine structures.

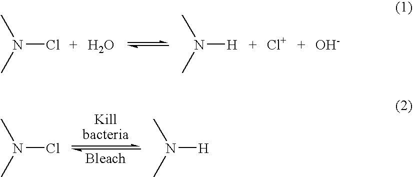

Once formed, it is possible to determine copolymer contents from the FT-IR spectra of the polymers (see, for example, Nyquist Appl. Spectrosc., 41, 797 (1987); Liu et al., Appl. Spectrosc., 50:349 (1996)).

In one embodiment, the present invention provides a method for preparing a polyolefin-graft-poly(amine moner) biocidal fiber. The method includes admixing a poly(α-olefin) fiber of formula V:

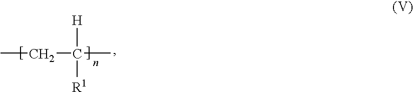

a monomer having formula VI or VII:

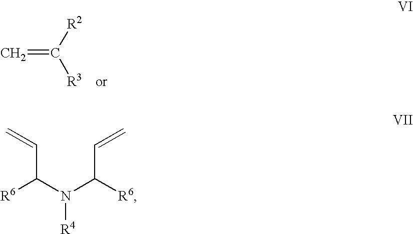

and a free radical generator in an extruder under conditions sufficient to form a graft polymer; extruding the graft polymer to produce a graft polymer fiber; and contacting the graft polymer fiber with a halogen generating source under conditions sufficient to form a biocidal fiber. The substituents R¹, R², R³, R⁴, R^{a}, R^{b}, R^{c} and R^{d} as defined above. R⁶ is —H or C₁₋₄alkyl. In one embodiment, R⁶ is —H.

Numerous applications for the biocidal polymers of the present invention exist. For instance, the biocidal polymers can provide biocidal protective clothing to personnel in the medical area as well as in the related healthcare and hygiene are. The regenerable and reusable biocidal materials can replace currently used disposable, nonwoven fabrics as medical textiles, thereby significantly reducing hospital maintenance costs and disposal fees. The microbicidal properties of the polymers of the present invention can be advantageously used for women's wear, underwear, socks, and other hygienic purposes. In addition, the microbicidal properties can be imparted to carpeting materials to create odor-free and germ-free carpets. Moreover, all germ-free environments, such as required in biotechnology and pharmaceutical industry, would benefit from the use of the microbicidal textiles of the present invention to prevent any contamination from air, liquid, and solid media.

The biocidal polymer are effective against a broad spectrum of microorganisms. Such microorganisms include, for example, bacteria, protozoa, fungi, viruses and algae. For example, the microorganisms include a minimum Gram positive and Gram negative bacteria, including resistant strains thereof, for example methicillan-resistant Staphylococcus aureus (MRSA), vancomycin-resistant Enterococci (VRE) and penicillin-resistant Streptococcus pneumoniae (PRSP) strains. In one embodiment, the microorganisms also include all bacteria (Gram+, Gram− and acid fast strains) and yeasts such as Candida albicans. In another embodiment, the microorganisms include all bacteria (Gram+, Gram−, and acid fast), yeasts, and both envelope and naked viruses such as human influenza, rhinovirus, poliovirus, adenovirus, hepatitis, HIV, herpes simplex, SARS, and avian flu.

Moreover, the biocidal polymers described herein can be employed in a variety of disinfecting applications, such as water purification. They will be of importance in controlling microbiological contamination or growth of undesirable organisms in the medical and food industries. In addition, they can be used as preservatives and preventatives against microbiological contamination in paints, coatings, and on surfaces.

The biocidal compounds described herein can be employed in a variety of disinfecting applications. They will be of importance in controlling microbiological contamination on surfaces, for medical and dental applications, bandages, fabric materials, piping, paints, swimming pools, catheters, and the like. For example, the halogenated polymers will prevent the growth of undesirable organisms, such as the bacteria genera Staphylococcus, Pseudomonas, Salmonella, Shigella, Legionella, Methylobacterium, Klebsiella, and Bacillus; the fungi genera Candida, Rhodoturula, and molds such as mildew; the protozoa genera Giardia, Entamoeba, and Cryptosporidium; the viruses poliovirus, rotavirus, HIV, and herpesvirus; and the algae genera Anabaena, Oscillatoria, and Chlorella; and other sources of biofouling on surfaces. They will be of importance as preservatives and preventatives against microbiological contamination in paints, coatings, and on surfaces. They will be of particular importance to the medical field for use in ointments, bandages, sterile surfaces, and the like, and for the attachment to liners of containers used in the food processing industry. They can be used in conjunction with textiles for sterile applications, such as coatings or physical bonds to sheets or bandages used for burn victims or on microbiological decontamination suits.

### V. Experiments and Examples

The following examples are offered to illustrate, but not to limit the claimed invention.

### Materials

Iso-polypropylene powder was supplied by Total and ExxonMobil. 2,4-Diamino-6-diallylamino-1,3,5-triazine (NDAM), N-tertbutyl acrylamide (NTBA), acrylamide (AAM), methacrylamide (MAM) and styrene (St) commercially available from TCI and VWR, 4-vinylbenzyl dimethylhydantoin (VBDMH) and 3-allyl, 5,5-dimethylhydantoin (ADMH) synthesized in our libratory (Sun, Y. et al., Polym Sci Part A: Polym Chem, 39(19):3348 (2001)). 2,5-Dimethyl-2,5 (tert-butylperoxy) hexyne (DTBHY) and dicumyl peroxide (DCP) both commercially available from Aldrich were used as received. Toluene, acetone, methanol and xylene used in the purifications were reagent grade.

### Instrumentation

Capillary rheometer Galaxy V model 80525 (Kayeness Inc.) was used for fiber extrusion. FT-IR spectra were taken on a Nicollet Magana IR-560 spectrometer using thin hot pressed films (Nicolet Instruments, Madison, Wis.).

Modification of the PP was carried out in a 3-PC Brabender Plasticorder ATR (C. W. Brabender, USA) under purge of Nitrogen gas for reducing oxidation during reaction. FTIR spectra were taken on a Nicolet Magana IR-760 spectrometer by molding very thin polymer films to ensure that the Beer-Lambert law was fulfilled. Very thin films of the purified samples were obtained by pressing 0.1-0.15 g sample between PTFE covered aluminum sheets under 0.1 MPa pressure at 180° C. for 45 s. Thermal behavior of grafted samples was carried out with Shimadzu DSC-50 in a N2 atmosphere. Initially, the temperature of the samples was raised from 30° C. to 200° C. at a rate of 50° C./min in order to impart a uniform thermal history to all of the samples. Then the samples were cooled down to 30° C. at a rate of −50° C./min. Afterward, the samples were heated again from 30° C. to 200° C. at a rate of 10° C./min and the melting curves were taken at this time then the crystallization curves were taken when the samples were cooled down to 30° C. at a rate of −10° C./min. Thermal stability of grafted samples was performed by using thermogravimetric analysis (TGA) in a N₂ atmosphere with Shimadzu TGA-50. Grafting degree was determined with nitrogen analysis of the purified samples for at least two samples. To do so, the grafted polymers dried, pulverized, and analyzed for ¹⁵N. All ¹⁵N analyses were performed on a Europa Scientific Integra, a continuous flow Isotope Ratio Mass Spectrometer (IRMS) integrated with on-line combustion, at the University of California at Davis.

### Example 1

### General Functionalization of Polyolefin

Halamine precursor monomers were first incorporated to polypropylene fibers and then the fibers were activated by using diluted chlorine bleach. One monomer and one initiator were first hand mixed well with the polymer, and then the mixture was fed to the rheometer at 205° C. (DAM) or 190° C. for other monomers, respectively. After keeping for certain time for melting, extrusion was done at rate 20 mm/Min. The modified polymers were extracted with organic solvent to remove any un-reacted monomers and initiators and then employed in FTIR characterization.

Modification of the PP was carried out in a 3-PC Brabender Plasticorder ATR (C. W. Brabender, USA) at 200° C. and 50 rpm for 5 min, unless stated otherwise. Nitrogen gas was purged above the mixing chamber to reduce oxidation during reaction. All 40 g reactants (PP, monomer and peroxide) were dry mixed together for 5 min before their fast (<0.5 min) introduction in the preheated chamber.

### Example 2

### Chlorination of Precursor Graft Polymer

After extrusion all grafted samples were re-extruded through a novel process developed in our lab to achieve sub-micro fibers. This is a process to simulate production of microsiezed polypropylene fibers. To transform the halamine precursor grafted fibers into N-halamines, the grafted fibers were immersed in 0.1% NaOCl solutions in the presence of a nonionic wetting agent (Triton X-100) at room temperature for a certain period under constant shaking. After chlorination, the samples were washed thoroughly with distilled water, air-dried. The active chlorine contents of the chlorinated fibers were determined by titration based on an redox reaction.

### Example 3

This example illustrates the graft copolymerization of PP with N,N-diallylmelamine (NDAM).

Preparation of Graft Copolymers of Polypropylene-Graft-Poly(N,N-Diallylmelamine) using DCP as an Initiator

40 grams of PP, 0.825-2.475 grams (100-300 mole per million part of PP, mpm) of NDAM and 0.043-0.129 grams of DCP (4-12 mpm) were dry mixed together for 5 min before their fast (<0.5 min) introduction in the preheated chamber. After mixing at 50 rpm for 5 minute at 200° C., the product was quickly removed from the mixer and cooled in iced-water bath and granulated to size of less than 5 mm.

To remove unreacted monomer or homopolymer formed during grafting, 5 g of the grafted samples were dissolved in 100 mL boiling toluene for 30 min, and then the hot solution was dropped into 400 mL of acetone at room temperature. PP-g-NDAM precipitated from the mixture were separated by filtration, washed several times with acetone and then dried at 60° C. under vacuum to reach constant weight.

### Radical-Induced Grafting

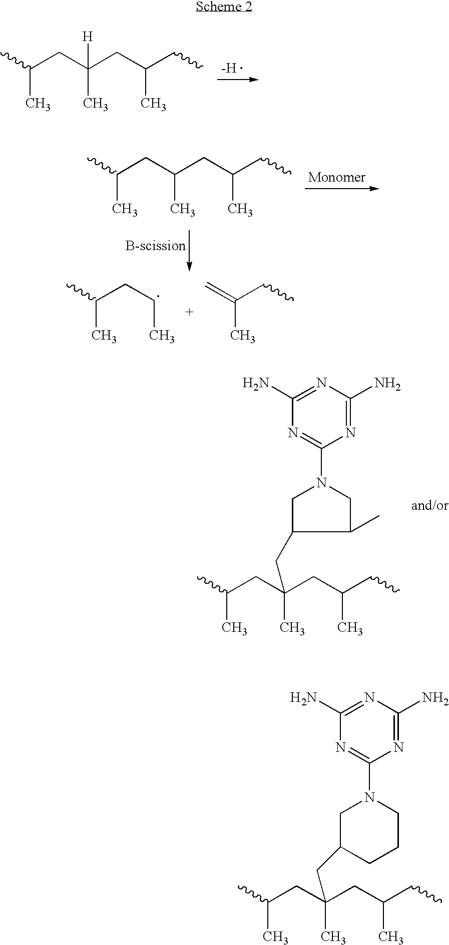

Radical grafting copolymerization of PP includes consecutive processes. First, peroxide initiator (DCP) thermally decomposed to primary free radicals that can abstract hydrogen from polymer backbone to generate macroradicals. The PP radicals can undergo β-scission to form secondary radicals, which can still react with monomers, or addition to monomers to form grafted copolymers (Scheme 2). The first process decreases viscosity of the polymer melts significantly, and reduction of viscosity can be estimated through mixer-torque during the grafting process. When the macroradicals react with a monomer molecule, this monomer may react with more monomer molecules forming longer grafting chain on the polymer backbone to form long chain branched polymers (LCB) and could be seen in torque evolution curve (Table 1). This grafting may be continued by radical transfer to the same or another polymer backbone or be terminated by radical combinations (Scheme 2).

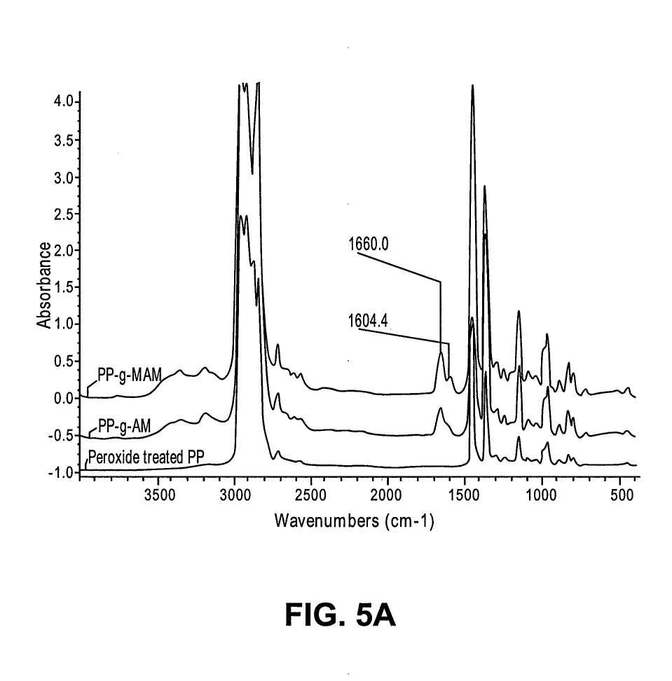

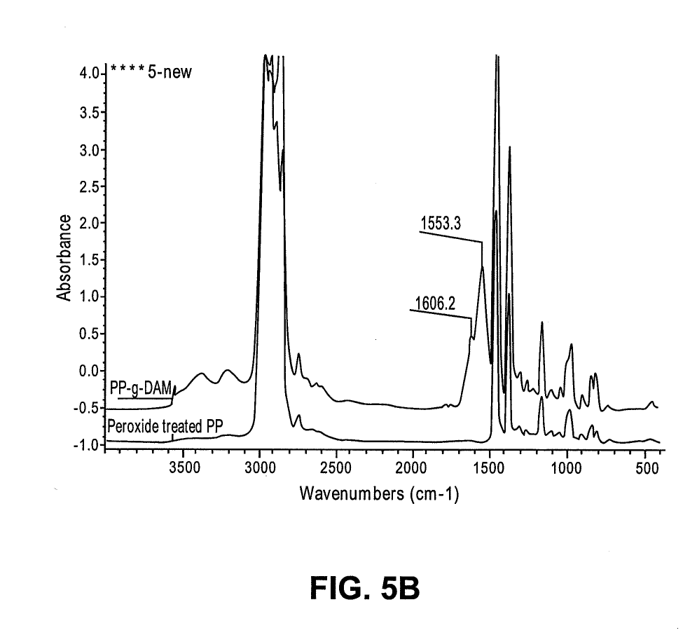

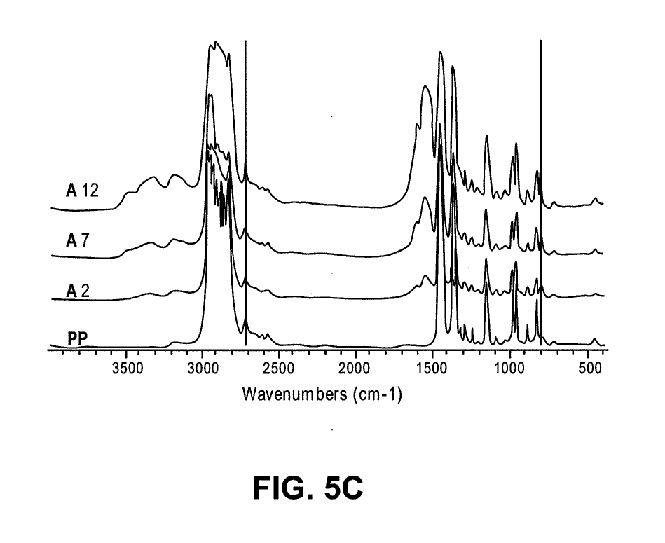

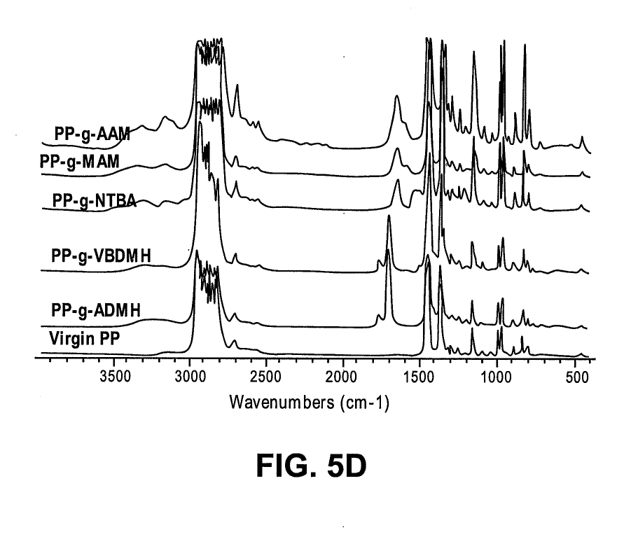

The structures of the grafted and purified samples were confirmed by FTIR spectroscopic analysis (FIG. 5C). The FTIR spectra of the grafted samples are shown in FIG. 1. Compared with the spectrum of the virgin PP, all the grafted samples showed additional peaks in the region of 1500-1700 cm⁻¹. The peaks at around 1615 and 1550 cm⁻¹ are believed to be bending deformations of amino-azine and planar triazine ring stretching vibration, respectively.

TABLE 1
Composition, thermal properties and grafting content of grafted samples

| | | Added | | Grafted | | | | | Final |
|---|---|---|---|---|---|---|---|---|---|
| Sample | PP | NDAM | DCP | NDAM | Tm₁ | Tm₂ | Tc | ΔHm | Torque |
| Code | (g) | (mpm) | (mpm) | (mpm) | (° C.) | (° C.) | (° C.) | (J/g) | (N · m) |
| A0 | 40 | 0 | 0 | 0 | 143.1 | 136.6 | 91.2 | 64.8 | 1.57 |
| A1 | 40 | 0 | 4 | 0 | 148.9 | 141.4 | 95.4 | 46.7 | 0.57 |
| A2 | 40 | 100 | 4 | 57.7 | 139.8 | N/A | 100.1 | 46.8 | 1.1 |
| A3 | 40 | 200 | 4 | 72.5 | 140.9 | N/A | 103.7 | 51.4 | 1.4 |
| A4 | 40 | 300 | 4 | 118.2 | 140.8 | N/A | 104.1 | 54.6 | 1.44 |
| A5 | 40 | 0 | 8 | 0 | 146.2 | 138.2 | 95.7 | 63.6 | 0.48 |
| A6 | 40 | 100 | 8 | 56.8 | 140.7 | N/A | 101.9 | 50.8 | 0.83 |
| A7 | 40 | 200 | 8 | 110.4 | 141.0 | N/A | 104.9 | 46.8 | 1.1 |
| A8 | 40 | 300 | 8 | 168.9 | 140.9 | N/A | 106.4 | 55.3 | 1.39 |
| A9 | 40 | 0 | 12 | 0 | 145.6 | 137.3 | 96.9 | 58.2 | 0.29 |
| A10 | 40 | 100 | 12 | 59.2 | 138.9 | N/A | 102.3 | 48.3 | 0.69 |
| A11 | 40 | 200 | 12 | 129.3 | 139.9 | N/A | 104.5 | 44.7 | 0.94 |
| A12 | 40 | 300 | 12 | 198.5 | 139.5 | N/A | 105.8 | 50.9 | 1.15 |

(mpm = mole per million part of PP)

Another band at 815 cm⁻¹ is out-of-plane ring deformation, a characteristic band of triazine ring containing two or three amine groups. This band also overlaps with absorption peak of the C—CH₃ vibration in the PP backbone. All the spectra are normalized with an internal standard peak at 2720 cm⁻¹, assigned to the C—H deformation as the PP reference. The intensity of the absorbance at 1615 cm⁻¹, a characteristic band of NDAM, increases with its concentration increase at all peroxide levels.

### Influence of Initiator and Monomer Content

Selection of proper initiators and concentration of the initiator are extremely important in the radical grafting copolymerization since they determine grafting efficiency and the number of grafting sites. FIGS. 11A and 11B indicate grafted contents of NDAM in the polymers under varied concentrations of the monomer and the initiator (DCP). At low monomer concentration (100 mpm), increasing peroxide concentration from 4 mpm to 12 mpm did not change grafting content (FIG. 11A), indicating that excess peroxide generated more polymer degradation, which was characterized by the reduction in end-torque (Table 1). As the monomer concentration increases (100 mpm to 300 mpm), grafted monomer content show a steady increase, revealing that the grafting copolymerization have reached balance with and passed the chain degradation reaction. Thus, the polymer β-scission during the reactive extrusion becomes controllable.

### Thermal Behavior

During the reactive extrusion process, degradation and grafting reactions may occur simultaneously on the polymer, which will result in changes of the molecular weight and its distribution as well as chain irregularity due to the grafting of polar groups to the polymer chains. In order to investigate the effects of the extent of grafting on crystallization and melting behavior of the polymer differential scanning calorimetry (DSC) was carried out in a N₂ atmosphere. It was observed that the introduction of branching in the PP increases crystal nuclei density. This promotes faster crystallization, and hence, higher crystallization temperatures for branched materials as compared to linear materials. Lower melting point (Tₘ) and higher crystallization temperatures (T_{c}) of the grafted samples reveal that grafting reaction successfully happened during the extrusion (Table 1). The higher T_{c} shows faster crystallization rate of the grafted samples due to presence of polar grafted groups on the polymer backbone. The heats of fusion from heating curves (ΔH) of various grafted samples are given in Table 1, too. As the heat of fusion is directly proportional to the amount of crystalline PP in the sample, it decreases with an increase in grafting content. An apparent decrease in heat of fusion was caused by the decrease of crystalline PP in grafted samples as a consequence of incorporation of the monomers.

### Example 4

This example illustrates the graft copolymerization of PP with N-tert-butyl acrylamide (NTBA).

### Preparation of Graft Copolymers of Polypropylene-Graft-Poly(N-t-Butyl Acrylamide)

Modification of the PP with NTBA was performed at 185° C. and 50 rpm for 5 min. Nitrogen gas was purged above the mixing chamber to reduce oxidation during reaction. 35 grams of PP, 0.889-1.778 grams (200-400 mpm) of NTBA and 0.038-0.114 grams of DCP (4-12 mpm) were dry mixed together for 5 min before their fast (<0.5 min) introduction in the preheated chamber. After mixing the final product was frozen in iced-water bath and granulated to size of less than 5 mm. Similarly, the grafted samples were purified by dissolving and subsequent precipitation.

### FTIR Analysis

The structure of the purified samples was confirmed by FTIR spectrum. Compared with the spectrum of the virgin PP, new absorption peak at 1650 cm⁻¹ was observed, which can be assigned to the absorption of the secondary amide, amide I (—C═O) of NTBAM. The absorptions at 2723 cm⁻¹ can be assigned to the characteristic absorption of the PP skeleton (the C—H deformation) was chosen as an internal reference in this case. The spectra show that increasing concentration of NTBA could increase the graft degree.

Influence of Initiators and Monomer content

The effect of the initial peroxide concentration and monomer concentration on the grafting content of NTBA are illustrated in FIGS. 12A and 12B. Despite of expected, the initial peroxide concentration doesn't affect the degree of monomer grafting level. As shown in FIG. 12A, when the initial peroxide concentration was increased from 4 mpm to 12 mpm, there is no significant change in grafting yield of monomer for all of the initial monomer concentration. It means adding more peroxide only increase the portion of macroradicals and hence increase the chance of polymer scission (refer to Table 2). Based on FIG. 12B, as the initial concentration of NTBA was increased from 200 mpm to 400 mpm, regardless of the initial peroxide concentration, the grafting yield increased from about 80 to 140 mpm. This indicates that the incorporated monomer content goes through a steady increase. More interestingly, the grafting yield is a monotonic function of the monomer concentration, which is contradicted to radical copolymerization of MAH onto PP.

TABLE 2
composition of NTBA grafted samples

| | | Added | | | Grafted | Final |
|---|---|---|---|---|---|---|
| Sample | PP | NTBA | DCP | St | NTBA | Torque |
| Code | (g) | (mpm) | (mpm) | (mpm) | (mpm) | (N · m) |
| B0 | 40 | 0 | 0 | 0 | 0 | 1.57 |
| B1 | 40 | 0 | 4 | 0 | 0 | 0.57 |
| B2 | 40 | 200 | 4 | 0 | 88.7 | 0.39 |
| B3 | 40 | 300 | 4 | 0 | 108.7 | 0.86 |
| B4 | 40 | 400 | 4 | 0 | 145.0 | 0.91 |
| B5 | 40 | 0 | 8 | 0 | 0 | 0.48 |
| B6 | 40 | 200 | 8 | 0 | 83 | 0.54 |
| B7 | 40 | 300 | 8 | 0 | 115.4 | 0.66 |
| B8 | 40 | 400 | 8 | 0 | 133.0 | 0.67 |
| B9 | 40 | 0 | 12 | 0 | 0 | 0.29 |
| B10 | 40 | 200 | 12 | 0 | 83.5 | 0.41 |
| B11 | 40 | 300 | 12 | 0 | 112.5 | 0.44 |
| B12 | 40 | 400 | 12 | 0 | 137.3 | 0.48 |
| B13 | 40 | 300 | 4 | 150 | 72.1 | 1.64 |
| B14 | 40 | 300 | 4 | 300 | 53.4 | 1.65 |
| B15 | 40 | 300 | 4 | 450 | 52.4 | 1.87 |
| B16 | 40 | 300 | 8 | 300 | 87.1 | 1.69 |
| B17 | 40 | 300 | 12 | 300 | 86.4 | 1.72 |
| B18 | 40 | 300 | 16 | 300 | 95.9 | 1.54 |

Effect of adding St on the grafting yield

FIG. 13A shows the effect of initial peroxide concentration on the grafting yield of NTBA and the comonomer St. As expected, in the case of St, the higher the initial peroxide concentration, the higher the grafting yields of St, which is in controversy with NTBA grafting yield. It is also shown that when St was added as comonomer, the grafting yield of NTBA did not increase, unlike the melt free-radical grafting of GMA and MAH. In its place, the grafting yield of NTBA was decreased as compared to the cases where St was not added.

The effect of concentration ratio of NTAB and St was shown in FIG. 13B, when the NTBA and DCP concentration were fixed at 300 and 4 mpm, respectively. The graft degree of St increased with increasing concentration of St. Whereas, increasing the concentration ratio of [St]/[NTBA] from 0 to 1.5 mole/mole decreased the grafting yield of NTBA from about 109 mpm to 52 mpm. At the same time the grafting yield of St was increased more than two times. This means presence of second monomer (St) adversely affects the grafting yield of the NTBA.

The only advantage of using St as co-monomer lies in is ability to reduce β-scission of PP chains. As shown in table 2, the more St is added, the higher end-torque of the grafting process. The final torque of the NTBA+St system increases with increasing [St]ᵢ/[NTBA]ᵢ. When this latter is 1.5 mol/mol, the final torque of the grafting system is more than twice as high as that of the NTBA system and even is higher than that of the virgin PP. Since no gel formed for grafted samples, it suggests that free radically grafting St onto PP could be an interesting way to create long chain branching PP.

### Example 5

This example illustrates the graft copolymerization of PP with N,N-diallylmelamine (NDAM), N-tert-butyl acrylamide (NTBA), acrylamide (AAM), methacrylamide (MAM), 4-vinylbenzyl dimethylhydantoin (VBDMH) and 3-allyl, 5,5-dimethylhydantoin (ADMH).

Preparation of Graft Copolymers of Polypropylene-Graft-Poly(N,N-Diallylmelamine) using DTBHY as an Initiator

A mixture containing 40 grams PP, 2.475 grams NDAM (300 mpm) and 0.11 grams DTBHY (10 mpm) were dry mixed together for 5 min and introduced in the preheated chamber for at 50 rpm for 5 min at 200° C. Similarly purification was done as discussed above.

### Preparation of Graft Copolymers of Polypropylene-Graft-Polyacrylamide

A mixture containing 40 grams PP, 0.852 grams AAM (300 mpm) and 0.11 grams DTBHY (10 mpm) were dry mixed together for 5 min and introduced in the preheated chamber for at 50 rpm for 5 min at 185° C. Similarly purification was done as discussed above.

### Preparation of Graft Copolymers of Polypropylene-Graft-Polymethacrylamide

A mixture containing 40 grams PP, 1.02 grams AAM (300 mpm) and 0.11 grams DTBHY (10 mpm) were dry mixed together for 5 min and introduced in the preheated chamber for at 50 rpm for 5 min at 185° C. Similarly purification was done as discussed above.

### Preparation of Graft Copolymers of Polypropylene-Graft-Polymethacrylamide

A mixture containing 40 grams PP, 1.52 grams TBAM (300 mpm) and 0.11 grams DTBHY (10 mpm) were dry mixed together for 5 min and introduced in the preheated chamber for at 50 rpm for 5 min at 185° C. Similarly purification was done as discussed above.

Preparation of Graft Copolymers of polypropylene-graft-poly-4-vinylbenzyl Dimethylhydantoin

A mixture containing 40 grams PP, 2.93 grams VBDMH (300 mpm) and 0.11 grams DTBHY (10 mpm) were dry mixed together for 5 min and introduced in the preheated chamber for at 50 rpm for 5 min at 185° C. Similarly purification was done as discussed above.

Preparation of Graft Copolymers of polypropylene-graft-poly3-allyl, 5,5-dimethylhydantoin

A mixture containing 40 grams PP, 2.02 grams ADMH (300 mpm) and 0.11 grams DTBHY (10 mpm) were dry mixed together for 5 min and introduced in the preheated chamber for at 50 rpm for 5 min at 185° C. Similarly purification was done as discussed above.

### Controlled Melt Free-Radical Graft Polymerization

Radical grafting copolymerization of PP includes two key steps. First, peroxide initiator thermally decomposes to free radicals; the radicals undergo hydrogen abstraction on polymer backbone to form macroradicals; and the macroradicals initiate polymerization of vinyl monomers. The most often cited side reaction is polymer degradation caused by the initially formed radical undergoing β-scission, which can be estimated by final torque of grafting reaction (Table 3). The initiator is proven quite effective in producing polymer radicals, but the polymer radicals also causes significant β-session reactions if the radicals are not dispatched. Allyl monomer showed the lowest end-torque compare to vinyl monomers and even diallyl monomer, which could be caused by inhibition properties of allyl monomers to radical polymerization and increased β-session reactions. While vinyl monomers are much more reactive with the polymer radicals, any resulted PP macroradicals will be quickly consumed by the monomers, which lead to less β-session reactions compare to allyl monomer. Interestingly, the end-torque of diallyl monomer is even higher than vinyl monomer, which could be due to intramolecular cyclization of diallyl monomer as well as rigidity of melamine pendant group.

TABLE 3
Characterization of grafted samples

| | Grafted | End- | | | | |
|---|---|---|---|---|---|---|
| | monomer | torque | Tₘ | T_{c} | T^{a}ᵢₙᵢₜ | T^{b}_{50%} |
| | (mpm) | (N · m) | (° C.) | (° C.) | (° C.) | (° C.) |
| Virgin PP | N/A | 1.60 | 144.4 | 91.2 | 390 | 454 |
| PP-g-NDAM | 162 | 1.20 | 139.6 | 103.6 | 390 | 463 |
| PP-g-AAM | 57 | 0.65 | 145.5 | 98.5 | 379 | 452 |
| PP-g-NTBA | 115 | 0.75 | 141.0 | 95.3 | 400 | 460 |
| PP-g-MAM | 150 | 0.92 | 143.1 | 102.9 | 367 | 452 |
| PP-g-VBDMH | 140 | 0.95 | 140.6 | 102.4 | 387 | 460 |
| PP-g-ADMH | 30 | 0.40 | 146.6 | 96.5 | 373 | 450 |
| Only peroxide | N/A | 0.35 | 145.7 | 97.4 | 370 | 448 |

^{a}Initial decomposition temperature.
^{b}50% decomposition temperature

### FTIR Spectroscopy

The grafted fibers were characterized by FTIR spectroscopy. FIG. 5A shows spectra of AM-g-PP and MAM-g-PP as well as peroxide-treated-PP fibers. These spectra reveal characteristic peaks of 1660 cm⁻¹ (amide band I due to C═O stretch) and 1605 cm⁻¹ amide band II due to NH deformation). Also FIG. 5B shows the spectra of DAM-g-PP fibers and characteristics peaks of tri-azine ring.

The structure of the purified samples was confirmed by FTIR spectrum. Compared with the spectrum of the virgin PP, additional peaks in the region of 1500-1800 cm⁻¹ were observed in the spectrum of all the grafted samples (FIG. 5D). These spectra show characteristic peaks of 1660 cm⁻¹ (amide band I due to C═O stretch) and 1605 cm⁻¹ (amide band II due to NH deformation) for acrylamide, methacrylamide and N-tertbutyl acrylamide grafted samples. Also the spectrum of melamine derivative grafted sample shows the characteristics peaks of 1613 and 1550 cm⁻¹ which are believed to be caused by bending deformation and stretching vibration of planar triazine ring, respectively. Another band in the 815 cm⁻¹ peak, is characteristics band of triazine ring containing two or three amine groups. In addition, the spectra of hydantoin derivative grafted polymers show the characteristics peaks of 1770 and 1710 cm⁻¹ which are assigned to the amide and imide bonds of the hydantoin structure, respectively.

### Thermal Analysis

Lower melting point (Tₘ) and higher crystallization temperatures (T_{c}) of the grafted samples reveal that grafting successfully happens during the extrusion. The higher T_{c} shows faster crystallization rate of the grafted samples due to presence of polar grafted groups on the polymer backbone. The initial decomposition (Tᵢₙᵢₜ) and half-decomposition (T₅₀) temperatures of the grafted polymers were recorded from their TGA curves and are given in Table 3. The T₅₀ of grafted samples were higher than virgin PP, except for PP-g-AAM and PP-g-ADMH, indicating the improvement in thermal stability due to incorporation of the grafted monomers. The reason for having lower Tᵢₙᵢₜ and T₅₀ for PP-g-AAM and PP-g-ADMH may attribute to main chain secession during grafting.

### Example 6

### Preparation of Sub-Micro Graft Copolymer Fibers

All graft copolymerized samples produced in Example 5 were similarly convert to sub-micro fibers via melt mixing with cellulose acetate butyrate (CAB; butyryl content 35-39%). A total of 6 grams mixture contains of 4.8 grams CAB and 1.2 grams modified PP was fed into a capillary rheometer LCR 8052 (Kayness, Pa. 19543) at 200° C. The blends were then extruded at ran rate of 10 mm/min through capillary die, hot-drawn and air cooled to room temperature. The obtained extrudates in fiber form were immersed in acetone at room temperature for 15 mins to remove CAB from the blends.

To increase specific surface area of modified PP fibers the extrudates obtained above were palletized and reprocessed under the same processing temperature and ram rate to reach ultra fine fibers. The ultra fine fibers produced with an average diameter of 0.6 μm and diameter distribution ranging from 0.48 to 0.75 μm.

### Example 7

### Preparation of Micro and Sub-Micro Polypropylene-g-Poly(NDAM) Fibers

Modified PP fibers were prepared by mixing cellulose acetate butyrate (CAB; butyryl content 35-39%) and NDAM modified PP at weight ratios of 80 to 20. A total of 6 grams mixture contains of 4.8 grams CAB and 1.2 grams PP-g-NDAM was fed into a capillary rheometer LCR 8052 (Kayness, Inc., PA 19543) at 200° C. The ratio of length to diameter of the capillary was 30, and the diameter of the capillary was 1 mm. The samples were preheated for 3 min at test temperature before measuring. The blends were then extruded through capillary die, hot-drawn at the die exit by a take-up device and air cooled to room temperature. The obtained extrudates in fiber form were immersed in acetone at room temperature for 15 minutes to remove CAB from the blends. Then, the sub-micro grafted PP fibers were produced in continuous yarns form with individual sub-micro fibers having an average diameter of 6 μm and diameter distribution ranging from 450 to 850 μm.

### Example 8

### Preparation of Micro and Sub-Micro Polypropylene-g-Poly(NTBA) Fibers

PP-g-NTBA fibers were similarly prepared by mixing cellulose acetate butyrate (CAB; butyryl content 35-39%) and NTBA modified PP. A total of 6 grams mixture contains of 4.8 grams CAB and 1.2 grams PP-g-NTBA was fed into a capillary rheometer LCR 8052 (Kayness, Pa. 19543) at 200° C. The ratio of length to diameter of the capillary was 30, and the diameter of the capillary was 1 mm. The samples were preheated for 3 min at test temperature before measuring. The blends were then extruded through capillary die at 10 mm/min ram rate, hot-drawn and air cooled to room temperature. The obtained extrudates in fiber form were immersed in acetone at room temperature for 15 mins to remove CAB from the blends. Then, the sub-micro grafted PP fibers were produced in continuous yarns form with individual sub-micro fibers having an average diameter of 6 μm and diameter distribution ranging from 4 to 8.5 μm.

### Example 9

### Preparation of N-Halamine Biocidal Fibers

To convert the precursor structures synthesized in Example 8 to N-halamine the sub-micro fibers were immersed in diluted chlorine bleach (approx. 1500 ppm available chlorine) containing 0.05 wt % of a nonionic wetting agent (Triton TX-100) for 45 min at room temperature. Then the fibers washed thoroughly with excess amount of distilled water, and air dried. Redox titration method was used to quantify the available active chlorine content of the grafted samples. To do so, the activated sample was immersed in 0.001 N sodium thiosulfate solution for 45 min, and then excess amount of sodium thiosulfate was titrated with 0.001 N iodine solution. The available active chlorine of the grafted samples was then calculated from eq. (1):

M_{c1}=35.45(V₂−V₁)×N/2W (1)

Where V₁, V₂ and N represent the volumes (mL) and concentration of the iodine solution used in the titration of the sodium thiosulfate solutions for the activated samples and controls, respectively, and W is the mass (g) of the activated sample.

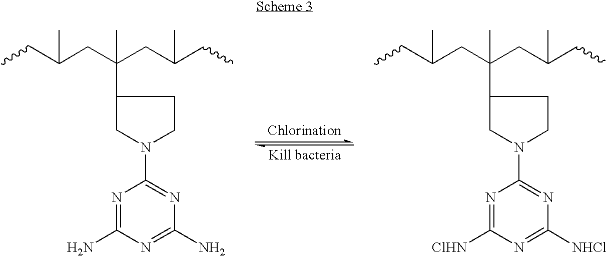

The reaction between NDAM and PP in reactive extrusion was further confirmed by chlorination studies, as illustrated in Scheme 3. Virgin PP fibers did not show any evidence of the presence of active chlorine in the titration experiments, but grafted fibers exhibited sufficient active chlorine contents (FIG. 14A). With an increase in the grafted monomer, the chlorine content increases in all cases, but at different levels. With an increase in initiator/monomer ratio at lower monomer concentration (100 mpm), the active chlorine content on the grafted samples decreased, this might be due to oxidation of amino-azine groups of the triazine ring. A comparison of the graft yield and active chlorine content of the resultant fibers indicated that only small percentage of the amino-azine groups in the grafted NDAM side chains was transformed into N-halamines during chlorination. Without being bound by any particular theory, such a result might be caused by the hydrophobic nature of the PP backbone which restricts the accessibility of chlorinating agents to all amino-azine groups, and only the portion which are on the surface of the fibers were accessible and converted to halamine structures.

### Example 10

### Antimicrobial Activity Studies of the Graft Copolymer Fibers

Antibacterial properties of the NDAM grafted PP samples were examined according to a modified American Association of Textile Chemist and Colorists (AATCC) test method 100 against gram-negative bacterium Escherichia coli K-12 (E. coli, UC Davis Microbiology Laboratory). 0.5 mL of an aqueous suspension containing 10⁵-10⁶ colony forming units (CFU)/mL E. coli was placed onto the surfaces of the half gram activated fibers in a sterilized container. After variable contact times, the inoculated samples were placed into 100 mL of 0.03% sodium thiosulfate aqueous solution to neutralize any active chlorine. The mixture was then vigorously shaken for 5 min. An aliquot of the solution was removed from the mixture and then serially diluted and 100 μL of each dilution was placed onto a nutrient agar plate. The same procedure was also applied to the virgin PP fibers as controls. Viable bacterial colonies on the agar plates were counted after incubation at 37° C. for 24 h. Bacterial reduction is reported according to the equation (2):

Percentage reduction of bacteria (%)=(A−B)/A×100 (2)

where A and B are the number of bacteria counted from control and activated fibers, respectively.

The results of biocidal properties of the chlorinated NDAM grafted PP fibers were examined against E. coli are shown in Table 4. The active chlorine content of the grafted polymers has a significant influence on the antimicrobial activity. All grafted fibers with sufficient active chlorine content provided powerful antibacterial properties against E. coli at a very short contact time. For A serial samples, the fibers could provide 99% reduction of E. coli after 10 min and reached 100% kill in less than 30 min of contact, whereas the other two serial samples provide total kill or 100% reduction at 10 min of contact time. Other features of melamine grafted PP fibers such as durability, renewability; storage life-span and rechargability are being studied and be published later.

TABLE 4
Influence of monomer and peroxide concentration and contact
time on the antimicrobial activity against E. coli

| NDAM | 4 mpm | | | 8 mpm | | | 12 mpm | | |
|---|---|---|---|---|---|---|---|---|---|
| (mpm) | 10 min | 30 min | 90 min | 10 min | 30 min | 90 min | 10 min | 30 min | 90 min |
| 100 | 99% | 100% | 100% | 99% | 100% | 100% | 99% | 100% | 100% |
| 200 | 100% | 100% | 100% | 100% | 100% | 100% | 100% | 100% | 100% |
| 300 | 100% | 100% | 100% | 100% | 100% | 100% | 100% | 100% | 100% |

### Example 11

### Effect of St/NTBA Ratio on Chlorine Content

The chlorine content of all grafted fibers produced in Example 8 was shown in FIG. 14B. With an increase in the grafted monomer, the chlorine content increases in all cases, but at different levels. With an increase in St/NTBA ratio, the active chlorine content on the grafted samples decreased, which is due to lower grafting content of NTBA in presence of St. It means the chance of copolymerization between two monomers is less when St concentration is low, because reactivity of St radical toward NTBA monomers is low.

### Example 12

### Effect of Fiber Diameters or Surface Area on Chlorine Content

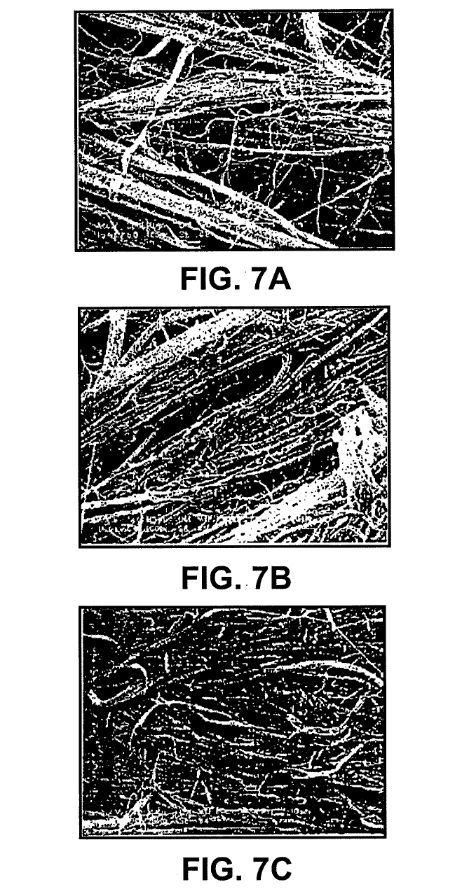

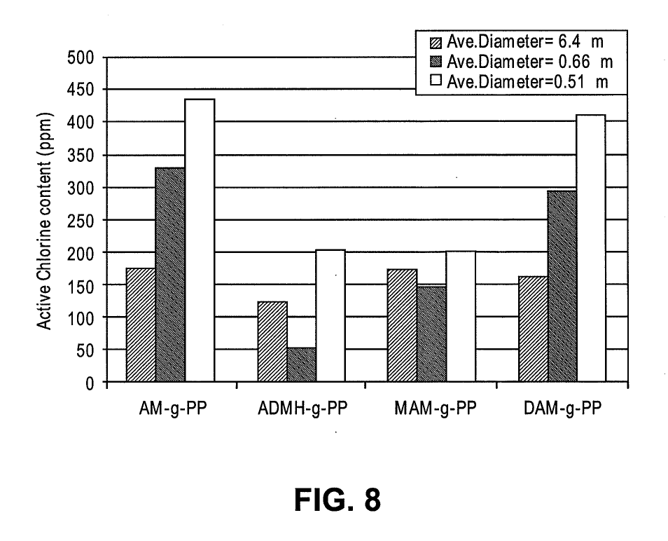

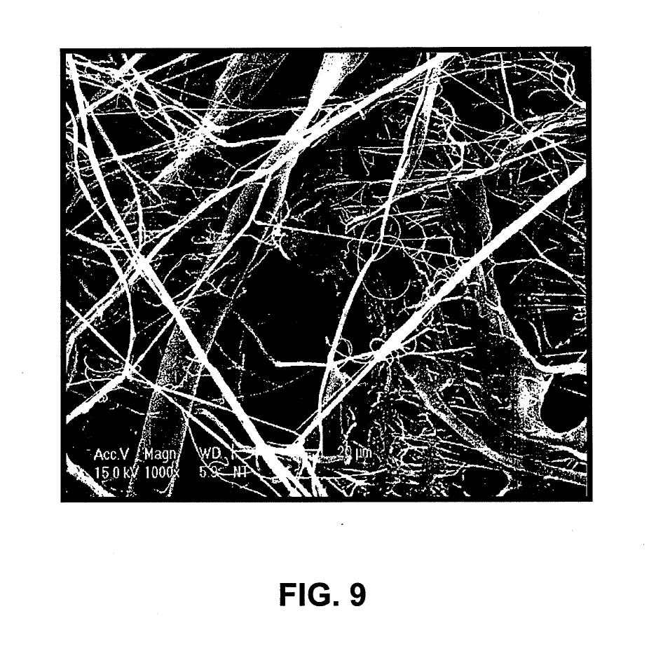

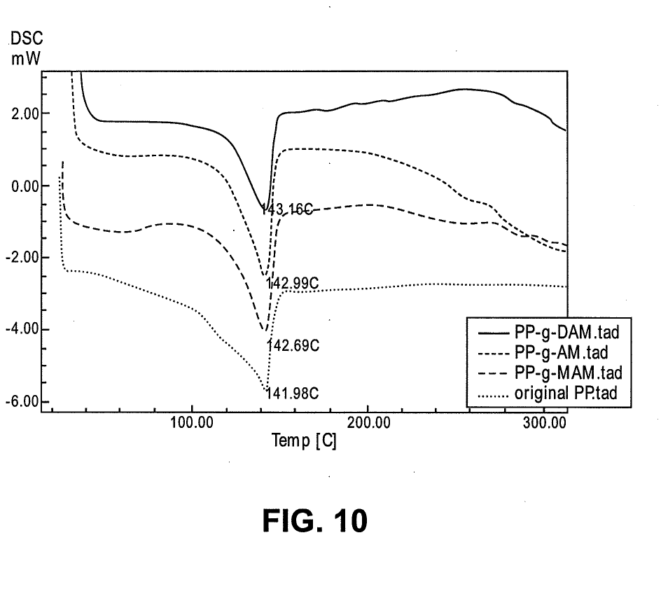

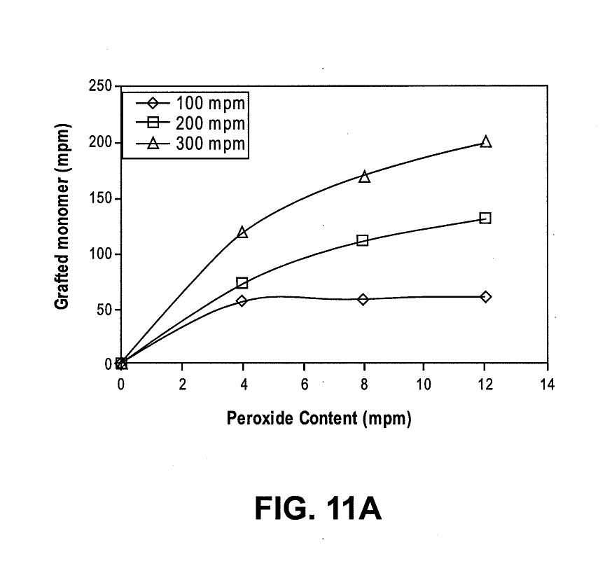

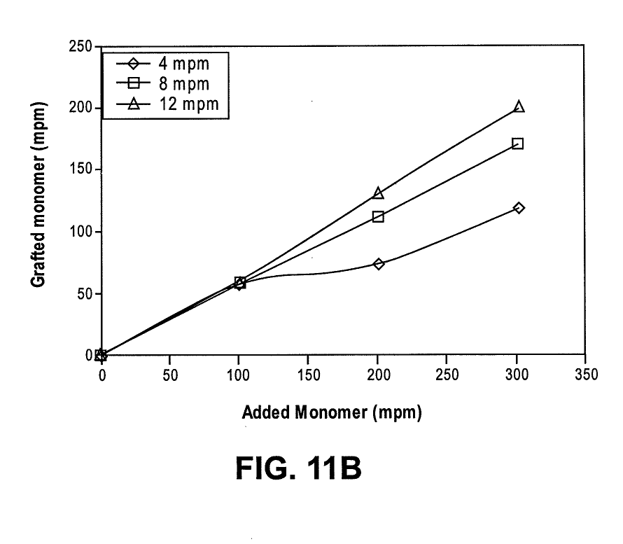

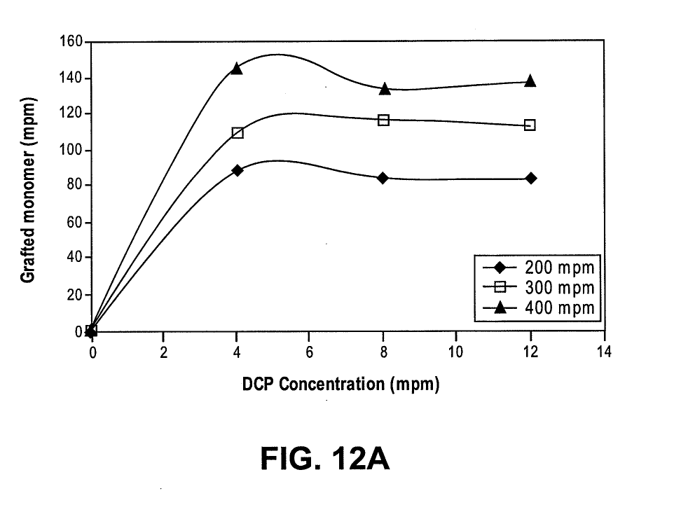

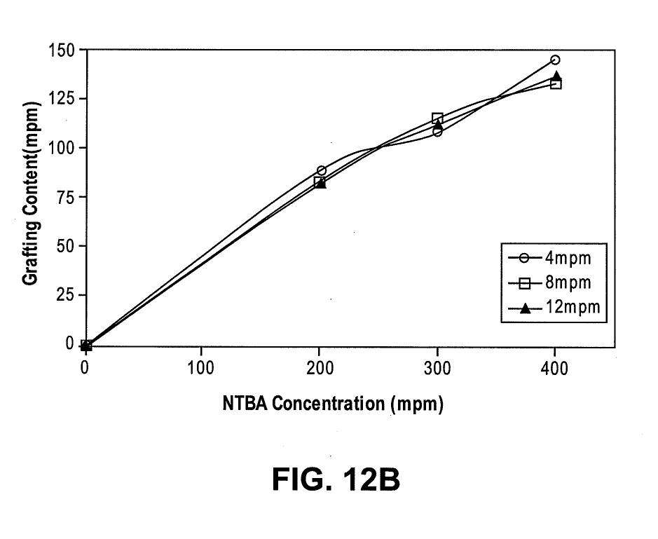

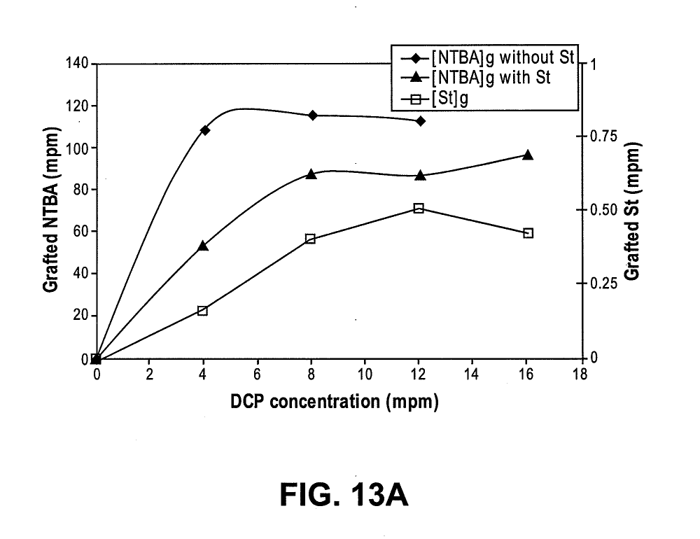

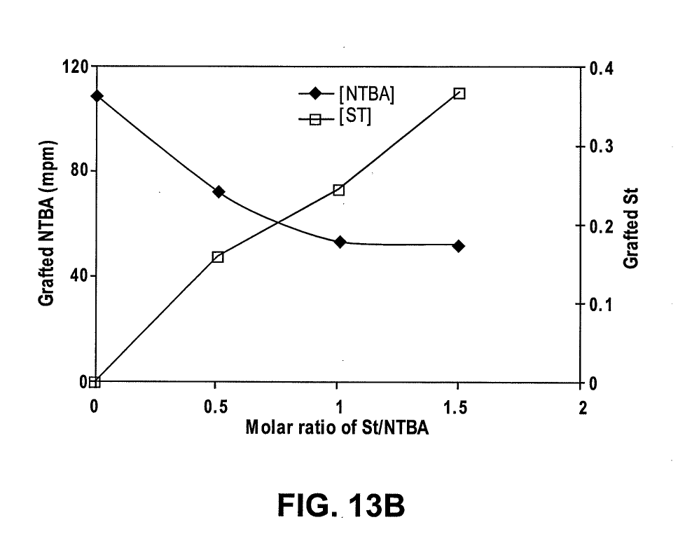

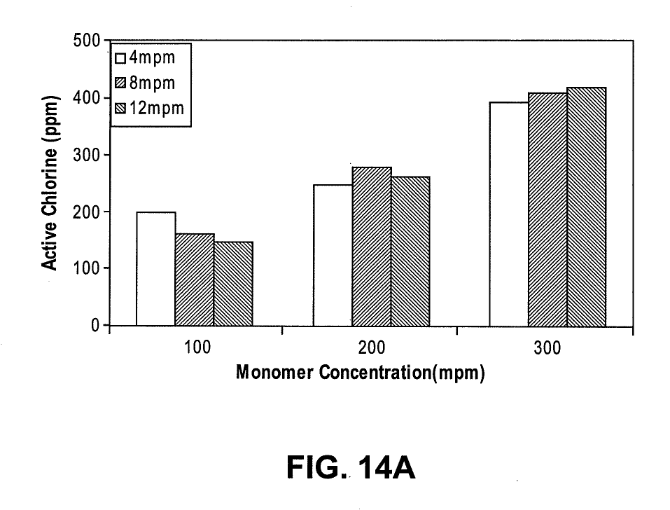

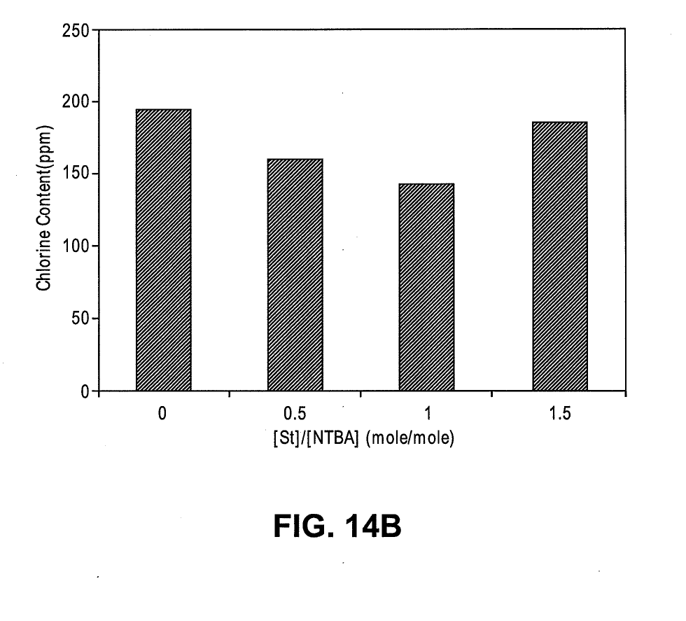

One characteristic that the grafted polypropylene fibers still maintain is hydrophobicity, which may slow biocidal functions of the fibers due to poor surface contact with bacterial suspension. To increase specific surface area of the modified PP fibers, sub-micro fibers were produced by repeated extrusions to reach ultra fine fibers. The SEM pictures are shown in FIG. 7. FIG. 8 shows the chlorine content of functionalized fibers with different average diameters. The results show that by increment in fiber fineness the chlorine content increase which implies direct relation between surface areas and antimicrobial functions.

FIG. 6B shows the active chlorine data for all grafted PP sub-micro and ultra fine fibers which produced in Example 6. One feature that the grafted polypropylene fibers still maintain is their hydrophobicity, which may slow biocidal functions of the fibers due to poor surface contact with bacterial suspension. Significant increase in active chlorine content of finer grafted fibers confirm that by increasing fiber fineness the chlorine content increased implying direct relation between surface contact and functionality of grafted fibers (FIG. 6B).

### Example 13

### Antimicrobial Activity Studies of Graft Copolymer Fibers

The biocidal properties of the chlorinated grafted fibers were produced in Example 12 were examined against E. coli following an AATCC test method 100-1999, and the results are shown in Table 5. The chlorine content of the grafted polymers has a significant influence on the antimicrobial activity. All grafted fibers with sufficient chlorine content provided powerful antibacterial properties against E. coli, especially the finer fibers. Since our previous studies showed that polymeric N-halamine will have the maximum antimicrobial efficiencies only when their active sites can make full contact with the microorganisms, this could be explained by hydrophobic properties of polypropylene fibers, that is, the N-halamine structures in the finer grafted fibers could make better contact with bacteria than that in coarser fibers, resulting in more kill. For samples with low chlorine content, longer contact time did not noticeably improve the antimicrobial performance. Rechargability is one of the important features of the grafted polymers which indicate most of the grafted polymers survive through several bleaching, washing and rebleaching, although more washing reduced the active chlorine content.

TABLE 5
Antimicrobial tests results of grafted samples

| | Average of Diameter = 6μ | | | | | Average of Diameter = 0.6μ | | | | |
|---|---|---|---|---|---|---|---|---|---|---|
| | Time | | | | | Time | | | | |
| | 1 h | 2 h | 4 h | 8 h | 16 h | 1 h | 2 h | 4 h | 8 h | 16 h |
| PP-g-ADMH | 5% | 25% | 20% | 30% | 45% | 30% | 40% | 45% | 68% | 80% |
| PP-g-NTBA | 85% | 99% | 100% | 100% | 100% | 90% | 100% | 100% | 100% | 100% |
| PP-g-AAM | 5% | 35% | 30% | 60% | 70% | 40% | 42% | 40% | 70% | 80% |
| PP-g-MAM | 20% | 55% | 80% | 98% | 100% | 40% | 80% | 100% | 100% | 100% |
| PP-g-NDAM | 100% | 100% | 100% | 100% | 100% | 100% | 100% | 100% | 100% | 100% |
| PP-g-VBDMH | 30% | 58% | 50% | 80% | 90% | 25% | 50% | 80% | 82% | 99% |

### Example 14

### Biocidal Efficacy

The halamine fibers were tested against E. coli following an AATCC test method 100. Table 6 shows the antibacterial efficacy of different grafted fibers. A 6 log reduction of E. coli makes the grafted polypropylene fibers as powerful as halamine grafted cotton fibers. Such products can be used in biological protective clothing as well as medical textiles.

TABLE 6
Antibacterial efficacy of grafted fibers

| | Reduction percentage of E. Coli |
|---|---|
| | (10⁸10⁹ CFU/ml) |
| PP-g-DAM | 100% |
| PP-g-MAM | 98.3% |
| PP-g-ADMH | 55% |

While the invention has been described by way of examples and in terms of the specific embodiments, it is to be understood that examples and embodiments described herein are for illustrative purposes only and the invention is not limited to the disclosed embodiments. It is intended to cover various modifications and similar arrangements as would be apparent to those skilled in the art. Therefore, the scope of the appended claims should be accorded the broadest interpretation so as to encompass all such modifications and similar arrangements. All publications, patents, and patent applications cited herein are hereby incorporated by reference in their entirety for all purposes.

1. A polyolefin-graft-poly(amine monomer) polymer fiber having a diameter less than 10 μm, said polymer fiber comprising a polyolefin main chain and a plurality of poly(amine monomer) side chains, wherein at least one of said plurality of side chains is linked to a tertiary carbon on said main chain through either a terminal —CH₂— or a terminal tertiary carbon moiety of the plurality of side chains to form a covalent bond and wherein:
said polyolefin main chain has a structure of formula (I): 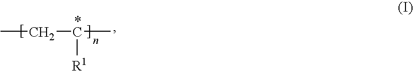
wherein
R¹ is selected from the group consisting of H, C₁₋₂₀alkyl, cycloalkyl-C₁₋₆alkyl, aryl, aryl-C₂₋₆-alkyl, heteroaryl, heteroaryl-C₂₋₆-alkyl and halide;
each said plurality of poly(amine monomer) side chains has a structure of formula (II): 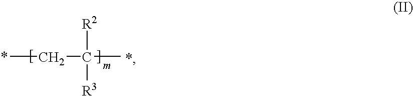
wherein
R² is —H or C₁₋₈alkyl;
R³ is selected from the group consisting of:
—C(O)NH₂, —C(O)NHR^{a}, —NH₂C(O)R^{a}, —NHR^{a}C(O)R^{a}, —R^{b}, —OR^{b}, —R^{c}, R^{c}—C₁₋₆alkyl, R^{c}-aryl and R^{c}—C₁₋₆alkyl-aryl;
wherein
each R^{a} is independently C₁₋₈alkyl or aryl;
R^{b} is selected from the group consisting of C₁₋₈alkyl, C₁₋₈haloalkyl, aryl, aryl-C₁₋₆alkyl, C₁₋₆alkylaryl, heterocycloalkyl, heterocycloalkyl-C₁₋₆alkyl, heterocycloalkyl-aryl, heterocycloalkyl-C₁₋₆alkyl-aryl, heteroaryl and heteroaryl-C₁₋₆alkyl, each of which is substituted with from 1-3 members selected from the group consisting of —OC(O)NHR^{d}, —S(O)₂NHR^{d}, —NHS(O)₂R^{d}, —C(O)NHR^{d}, —NHC(O)R^{d}, —NHC(O)NH₂, —NR^{d}C(O)NH₂, —NR^{d}C(O)NHR^{d}, —NHC(O)NHR^{d}, —NHC(O)N(R^{d})₂, —NHCO₂R^{d}, —NH₂, —NHR^{d}, —NR^{d}S(O)NH₂, —NR^{d}S(O)₂NHR^{d}, —NH₂C(═NR^{d})NH₂, —N═C(NH₂)NH₂, —C(═NR^{d})NH₂, —NH—NHR^{d} and —NHC(O)NHNH₂, wherein each R^{d} is independently an C₁₋₈alkyl or aryl and R^{b} is optionally further substituted with from 1-3 members selected from the group consisting of C₁₋₆alkyl, halogen, —NO₂, —OH, alkoxy, alkoxycarbonyl, carboxyl, —COOH and —CN;
R^{c} is heterocycloalkyl having at least one —NH— group as a ring member, optionally substituted with from 1-3 C₁₋₈alkyl substituents;
the asterisk symbols in formulas I and II represent points of attachment between the main chain and the side chains;
n is an integer from about 100 to about 20000; and
m is an integer from about 1 to about 20000.

2. The polymer fiber of claim 1, wherein R² is —H or —CH₃.

3. The polymer fiber of claim 1, wherein each of said plurality of side chains is linked to the main chain through either a terminal —CH₂— or a terminal tertiary carbon moiety of the plurality of side chains to form a covalent bond.

4. A polyolefin-graft-poly(amine monomer) polymer fiber comprising a polyolefin main chain and a plurality of poly(amine monomer) side chains, wherein at least one said plurality of side chains is linked to a tertiary carbon on said main chain through either a terminal —CH₂— or a terminal tertiary carbon moiety of the side chains to form a covalent bond and wherein:
said polyolefin main chain has a structure of formula (I): 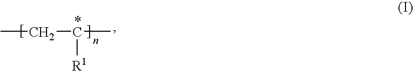
wherein
R¹ is selected from the group consisting of H, C₁₋₂₀alkyl, cycloalkyl-alkyl, aryl, aryl-C₂₋₆alkyl, heteroaryl, heteroaryl-C₂₋₆alkyl and halide;
each said plurality of poly(amine monomer) side chains is a sequence of q structure repeat units independently selected from the group consisting of: 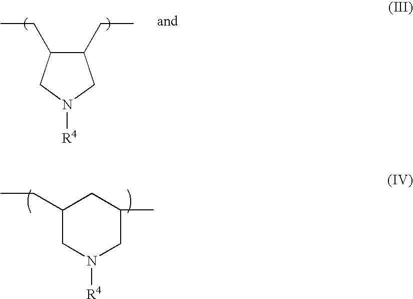
wherein the sequence of structure repeat units are joined together through carbon-carbon single bonds and each R⁴ is independently selected from the group consisting of aryl-C₁₋₆alkyl, aryl, heteroaryl and heteroaryl-C₁₋₆alkyl, each of which is substituted with from 1-3 R⁷ substituents selected from the group consisting of —OC(O)NHR^{e}, —S(O)₂NHR^{e}, —NHS(O)₂R^{e}, —C(O)NHR^{e}, —NHC(O)R^{e}, —NHC(O)NH₂, —NR^{e}C(O)NH₂, —NR^{e}C(O)NHR^{e}, —NHC(O)NHR^{e}, —NHC(O)N(R^{e})₂, —NHCO₂R^{e}, —NH₂, —NHR^{e}, —NR^{e}S(O)NH₂, —NR^{e}S(O)₂NHR^{e}, —NH₂C(═NR^{e})NH₂, —N═C(NH₂)NH₂, —C(═NR^{e})NH₂, —NH—NHR^{e} and —NHC(O)NHNH₂, wherein each R^{e} is independently an C₁₋₈alkyl or aryl and R⁴ is optionally further substituted with from 1-3 C₁₋₆alkyl substituents;
the asterisk symbols in formulas I and II represent points of attachment between the main chain and the side chains;
n is an integer from about 100 to about 20000; and
q is an integer from 1 to about 20000.

5. The polymer fiber of claim 3, wherein each of said plurality of side chains is linked to a tertiary carbon on said main chain through either a terminal —CH₂— or a terminal tertiary carbon moiety of the side chains to form a covalent bond.

6. The polymer fiber of claim 4, wherein at least one of said poly(amine monomer) side chains is a sequence of q structure repeat units of formula III.

7. The polymer fiber of claim 6, wherein each of said plurality of poly(amine monomer) side chains is a sequence of q structure repeat units of formula III.

8. The polymer fiber of claim 4, wherein R⁴ is heteroaryl substituted with from 1-2 R⁷ substituents.

9. The polymer fiber of claim 8, wherein R⁴ is 2,4-diamino-triazin-6-yl.

10. A biocidal polyolefin-graft-poly(amine monomer) polymer comprising a polyolefin main chain and a plurality of poly(amine monomer) side chains, wherein at least one said plurality of side chains is linked to either a secondary or a tertiary carbon of said main chain through either a terminal —CH₂— or a terminal tertiary carbon moiety of the side chains to form a carbon-carbon single bond and wherein said side chains comprise at least one member selected from the group consisting of —N(X)— and —NHX, wherein X is selected from the group consisting of —F, —Cl, —Br and —I.

11. The biocidal polymer of claim 10, wherein at least one of said plurality of side chains is linked to the tertiary carbon of the main chain through either a terminal —CH₂— group or a terminal tertiary carbon moiety of the side chains.

12. The biocidal polymer of claim 11, wherein each said plurality of side chains is linked to the tertiary carbon of the main chain through either a terminal —CH₂— group or a terminal tertiary carbon moiety of the side chains.

13. A biocidal polymer prepared by contacting a polymer fiber of claim 1 with a halogen source.

14. The biocidal polymer of claim 10, wherein said polyolefin main chain comprises a structure of formula I: 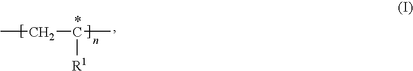
wherein R¹ is selected from the group consisting of H, C₁₋₂₀alkyl, cycloalkyl-C₁₋₆alkyl, aryl, aryl-C₂₋₆alkyl, heteroaryl, heteroar-C₂₋₆alkyl and halide; the asterisk symbol represents the point of attachment to the side chains; and n is an integer from about 100 to about 20000.

15. The biocidal polymer of claim 14, wherein R¹ is C₁₋₆alkyl.

16. The biocidal polymer of claim 15, wherein R¹ is —CH₃.

17. The biocidal polymer of claim 10, wherein each said plurality of poly(amine monomer) side chains has a structure of formula (II): 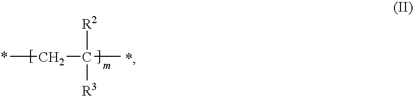
wherein
R² is —H or C₁₋₈alkyl;
R³ is selected from the group consisting of:
—C(O)NH₂, —C(O)NHR^{a}, —NH₂C(O)R^{a}, —NHR^{a}C(O)R^{a}, —R^{b}, —OR^{b}, —R^{c}, R^{c}—C₁₋₆alkyl, R^{c}-aryl and R^{c}—C₁₋₆alkyl-aryl; wherein R^{c} is heterocycloalkyl having at least one —NH— group as a ring member, optionally substituted with from 1-3 C₁₋₈alkyl substituents;
each R^{a} is independently C₁₋₈alkyl or aryl;
R^{b} is selected from the group consisting of C₁₋₈alkyl, C₁₋₈haloalkyl, aryl-C₁₋₆alkyl, C₁₋₆alkylaryl, heterocycloalkyl, heterocycloalkyl-C₁₋₆alkyl, heterocycloalkyl-aryl, heterocycloalkyl-C₁₋₆alkyl-aryl, aryl and heteroaryl-C₁₋₆alkyl, each of which is substituted with from 1-3 R⁵ substituents selected from the group consisting of —OC(O)NHR^{d}, —S(O)₂NHR^{d}, —NHS(O)₂R^{d}, —C(O)NHR^{d}, —NHC(O)R^{d}, —NHC(O)NH₂, —NR^{d}C(O)NH₂, —NR^{d}C(O)NHR^{d}, —NHC(O)NHR^{d}, —NHC(O)N(R^{d})₂, —NHCO₂R^{d}, —NH₂, —NHR^{d}, —N(R^{d})₂, —NR^{d}S(O)NH₂, —NR^{d}S(O)₂NHR^{d}, —NH₂C(═NR^{d})NH₂, —N═C(NH₂)NH₂, —C(═NR^{d})NH₂, —NH—NHR^{d} and —NHC(O)NHNH₂, wherein each R^{d} is independently an C₁₋₈alkyl or aryl, and R^{b} is optionally further substituted with 1-3 members selected from the group consisting of C₁₋₆alkyl, halogen, —NO₂, —OH, alkoxy, alkoxycarbonyl, carboxyl, —COOH and —CN;
the asterisk symbols represent points of attachment to the main chain; and
m is an integer from about 100 to about 20000.

18. The biocidal polymer of claim 17, wherein R² is —H or —CH₃ and R³ is —C(O)NH₂, —C(O)NHR^{a}, —NH₂C(O)R^{a}, —NHR^{a}C(O)R^{a}, heterocycloalkyl-C₁₋₆alkyl, heterocycloalkyl-C₁₋₆alkyl-aryl and —X¹—R⁵, wherein the heterocycloalkyl has at least one —NH— group as a ring member and —X¹— is a C₁₋₆alkylene, optionally substituted with from 1-3 members selected from the group consisting of C₁₋₆alkyl, halogen, —NO₂, —OH, alkoxy, alkoxycarbonyl, carboxyl, —COOH and —CN.

19. The biocidal polymer of claim 18, wherein R³ is selected from the group consisting of: 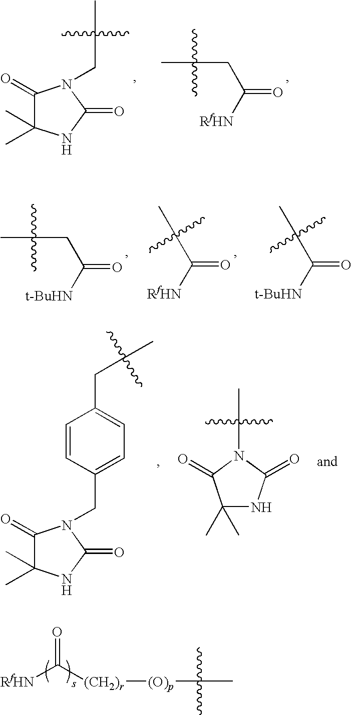
wherein each R^{f} is independently —H, C₁₋₆alkyl or aryl; r is an integer from 0 to 20; p is 0 or 1; s is 0 or 1, with the proviso when s is 0, r is not 0; and optionally, —(CH₂)ᵣ— in formula R^{f}NHC(O)ₛ(CH₂)ᵣ(O)ₚ— is substituted with from 1-2 members selected from C₁₋₈alkyl, aryl, halo, heteroaryl, —CN, —NO₂, hydroxyl and carboxyl.

20. The biocidal polymer of claim 19, wherein R^{f} is —H.

21. The biocidal polymer of claim 18, wherein the heterocycloalkyl is selected from the group consisting of tetrahydropyranyl, tetrahydrothiophenyl, piperidino, piperazinyl, N-methylpiperidin-3-yl, piperazino, N-methylpyrrolidin-3-yl, 3-pyrrolidino, 2-pyrrolidon-1-yl, morpholino, thiomorpholino, thiomorpholino-1-oxide, thiomorpholino-1,1-dioxide, pyrrolidinyl, imidazolidinyl, 2-oxo-imidazolidinyl, pyrazolidinyl, oxazolidinyl, thiazolidinyl and isoxazolidinyl.

22. The biocidal polymer of claim 10, wherein each said plurality of poly(amine monomer) side chains is a sequence of q structure repeat units independently selected from the group consisting of: 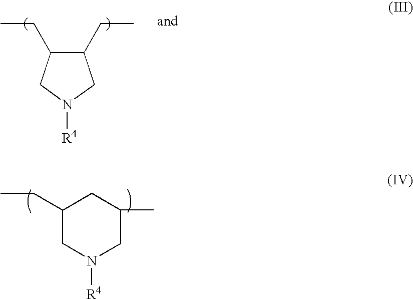
wherein R⁴ selected from the group consisting of aryl-C₁₋₆alkyl, aryl, heteroaryl and heteroaryl-C₁₋₆alkyl, each of which is substituted with from 1-3 R⁷ substituents selected from the group consisting of —OC(O)NHR^{e}, —S(O)₂NHR^{e}, —NHS(O)₂R^{e}, —C(O)NHR^{e}, —NHC(O)R^{e}, —NHC(O)NH₂, —NR^{e}C(O)NH₂, —NR^{e}C(O)NHR^{e}, —NHC(O)NHR^{e}, —NHC(O)N(R^{e})₂, —NHCO₂R^{e}, —NH₂, —NHR^{e}, —N(R^{e})₂, —NR^{e}S(O)NH₂, —NR^{e}S(O)₂NHR^{e}, —NH₂C(═NR^{e})NH₂, —N═C(NH₂)NH₂, —C(═NR^{e})NH₂, —NH—NHR^{e} and —NHC(O)NHNH₂, wherein each R^{e} is independently an C₁₋₈alkyl or aryl and R⁴ is optionally further substituted with from 1-3 C₁₋₆alkyl substituents; and q is an integer from 1 to about 20000.

23. The biocidal polymer of claim 22, having formula IIIa: 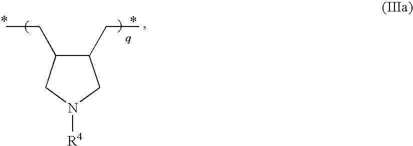
wherein the asterisk symbols represent points of attachment to the main chain.

24. The biocidal polymer of claim 22, wherein R⁴ is heteroaryl substituted with 2 R⁷ substituents.

25. The biocidal polymer of claim 24, wherein R⁴ is 2,4-diamino triazin-6-yl.

26. The biocidal polymer of claim 24, wherein the heteroaryl is selected from the group consisting of furyl, thienyl, pyridyl, pyrrolyl, oxazolyl), thiazolyl, imidazolyl, pyrazolyl, 2-pyrazolinyl, pyrazolidinyl, isoxazolyl, isothiazolyl, 1,2,3-oxadiazolyl, 1,2,3-triazolyl, 1,3,4-thiadiazolyl, pyridazinyl, pyrimidinyl, pyrazinyl, 1,3,5-triazinyl, 1,3,5-trithianyl, indolizinyl, indolyl, isoindolyl, 3H-indolyl, indolinyl, benzo[b]furanyl, 2,3-dihydrobenzofuranyl, benzo[b]thiophenyl, 1H-indazolyl, benzimidazolyl, benzthiazolyl, purinyl, 4H-quinolizinyl, quinolinyl, isoquinolinyl, cinnolinyl, phthalazinyl, quinazolinyl, quinoxalinyl, 1,8-naphthyridinyl, pteridinyl, carbazolyl, acridinyl, phenazinyl, phenothiazinyl and phenoxazinyl.

27. The polymer of claim 1, wherein said polyolefin is a poly(α-olefin).

28. The polymer of claim 1, wherein said polyolefin is tactic polypropylene.

29. A method for preparing a poly(α-olefin)-graft-poly(amine monomer) polymer, said method comprising:
admixing a poly(α-olefin) fiber of formula V: 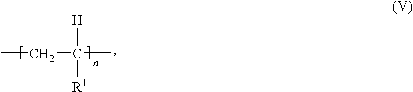
a monomer having formula VI or VII: 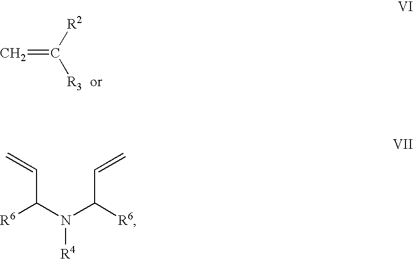
and a free radical generator under conditions sufficient to form a graft polymer; and
extruding said product to produce a graft polymer fiber;
wherein
R¹ is selected from the group consisting of H, C₁₋₂₀alkyl, cycloalkyl-alkyl, aryl, aryl-C₂₋₆alkyl, heteroaryl, heteroaryl-C₂₋₆alkyl and halide;
R² is —H or C₁₋₈alkyl;
R³ is selected from the group consisting of:
—C(O)NH₂, —C(O)NHR^{a}, —NH₂C(O)R^{a}, —NHR^{a}C(O)R^{a}, —R^{b}, —OR^{b}, —R^{c}, R^{c}—C₁₋₆alkyl, R^{c}-aryl and R^{c}—C₁₋₆alkyl-aryl;
wherein
each R^{a} is independently C₁₋₈alkyl or aryl;
R^{b} is selected from the group consisting of C₁₋₈alkyl, C₁₋₈haloalkyl, aryl, aryl-C₁₋₆alkyl, C₁₋₆alkylaryl, heterocycloalkyl, heterocycloalkyl-C₁₋₆alkyl, heterocycloalkyl-aryl, heterocycloalkyl-C₁₋₆alkyl-aryl, heteroaryl and heteroaryl-C₁₋₆alkyl, each of which is substituted with from 1-3 members selected from the group consisting of —OC(O)NHR^{d}, —S(O)₂NHR^{d}, —NHS(O)₂R^{d}, —C(O)NHR^{d}, —NHC(O)R^{d}, —NHC(O)NH₂, —NR^{d}C(O)NH₂, —NR^{d}C(O)NHR^{d}, —NHC(O)NHR^{d}, —NHC(O)N(R^{d})₂, —NHCO₂R^{d}, —NH₂, —NHR^{d}, —N(R^{d})₂, —NR^{d}S(O)NH₂, —NR^{d}S(O)₂NHR^{d}, —NH₂C(═NR^{d})NH₂, —N═C(NH₂)NH₂, —C(═NR^{d})NH₂, —NH—NHR^{d} and —NHC(O)NHNH₂, wherein each R^{d} is independently an C₁₋₈alkyl or aryl and R^{b} is optionally further substituted with from 1-3 members selected from the group consisting of C₁₋₆alkyl, halogen, NO₂ and CN;
R^{c} is heterocycloalkyl having at least one —NH— group as a ring member, optionally substituted with from 1-3 C₁₋₈alkyl substituents; and
R⁴ is aryl-C₁₋₆alkyl, C₁₋₆alkylaryl, aryl, heteroaryl and heteroaryl-C₁₋₆alkyl, each of which is substituted with from 1-3 R⁵ substituents; and
R⁶ is —H or C₁₋₄alkyl.

30. The method of claim 29, wherein R⁶ is —H.

31. The method of claim 29, further comprising: purifying said graft polymer fiber.

32. A method for preparing a polyolefin-graft-poly(amine monomer) biocidal fiber, said method comprising:
admixing a polyolefin fiber, a vinyl monomer having one or more —NH— or —NH₂ groups and a free radical generator in an extruder under conditions sufficient to form a graft polymer;
extruding said graft polymer to produce a graft polymer fiber; and
contacting said graft polymer fiber with a halogen generating source under conditions sufficient to form a biocidal fiber containing one or more —N(X)— and —NHX groups, wherein X is selected from the group consisting of —F, —Cl, —Br and —I.

33. A method for preparing a polyolefin-graft-poly(amine monomer) biocidal fiber, said method comprising:
admixing a polyolefin fiber, a vinyl monomer having one or more —NH— or —NH₂ groups and a free radical generator in an extruder under conditions sufficient to form a graft polymer;
extruding said graft polymer to produce a graft polymer fiber; and
contacting said graft polymer fiber with a halogen generating source under conditions sufficient to form a biocidal fiber containing one or more —N(X)— and —NHX groups, wherein X is selected from the group consisting of —F, —Cl, —Br and —I.

34. The method of claim 32, wherein the vinyl monomer is an α-olefin.

35. A method for preparing a polyolefin-graft-poly(amine monomer) biocidal fiber, said method comprising:
admixing a poly(α-olefin) fiber of formula V: 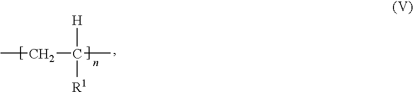
a monomer having formula VI or VII: 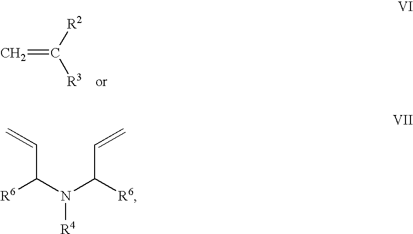
and a free radical generator in an extruder under conditions sufficient to form a graft polymer;
extruding said graft polymer to produce a graft polymer fiber; and
contacting said graft polymer fiber with a halogen generating source under conditions sufficient to form a biocidal fiber;
wherein R¹ is selected from the group consisting of H, C₁₋₂₀alkyl, cycloalkyl-alkyl, aryl, aryl-C₂₋₆alkyl, heteroaryl, heteroaryl-C₂₋₆alkyl and halide;
R² is —H or C₁₋₈alkyl;
R³ is selected from the group consisting of:
—C(O)NH₂, —C(O)NHR^{a}, —NH₂C(O)R^{a}, —NHR^{a}C(O)R^{a}, —R^{b}, —OR^{b}, —R^{c}, R^{c}—C₁₋₆alkyl, R^{c}-aryl and R^{c}—C₁₋₆alkyl-aryl;
wherein
each R^{a} is independently C₁₋₈-alkyl or aryl;
R^{b} is selected from the group consisting of C₁₋₈alkyl, C₁₋₈haloalkyl, aryl, aryl-C₁₋₆alkyl, C₁₋₆alkylaryl, heterocycloalkyl, heterocycloalkyl-C₁₋₆alkyl, heterocycloalkyl-aryl, heterocycloalkyl-C₁₋₆alkyl-aryl, heteroaryl and heteroaryl-C₁₋₆alkyl, each of which is substituted with from 1-3 R⁵ substituents selected from the group consisting of —OC(O)NHR^{d}, —S(O)₂NHR^{d}, —NHS(O)₂R^{d}, —C(O)NHR^{d}, —NHC(O)R^{d}, —NHC(O)NH₂, —NR^{d}C(O)NH₂, —NR^{d}C(O)NHR^{d}, —NHC(O)NHR^{d}, —NHC(O)N(R^{d})₂, —NHCO₂R^{d}, —NH₂, —NHR^{d}, —N(R^{d})₂, —NR^{d}S(O)NH₂, —NR^{d}S(O)₂NHR^{d}, —NH₂C(═NR^{d})NH₂, —N═C(NH₂)NH₂, —C(═NR^{d})NH₂, —NH—NHR^{d} and —NHC(O)NHNH₂, wherein each R^{d} is independently an C₁₋₈alkyl or aryl and R^{b} is optionally further substituted with from 1-3 members selected from the group consisting of C₁₋₆alkyl, halogen, NO₂ and CN;
R⁴ is aryl-C₁₋₆alkyl, C₁₋₆alkylaryl, aryl, heteroaryl and heteroaryl-C₁₋₆alkyl, each of which is substituted with from 1-3 R⁵ substituents; and
R⁶ is —H or C₁₋₄alkyl.

36. The method of claim 35, wherein R⁶ is —H.

37. The method of claim 35, wherein the monomer is selected from the group consisting of: 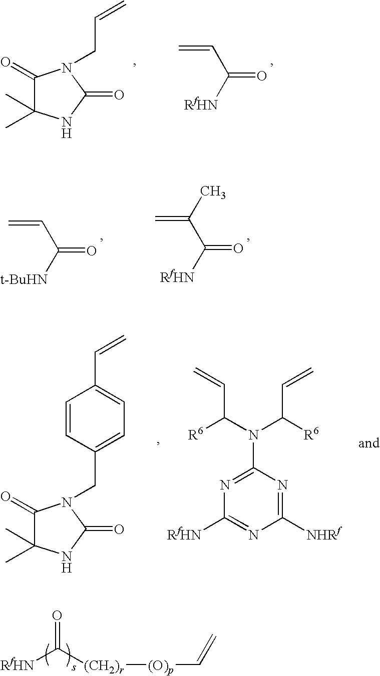
wherein each R^{f} is independently —H, C₁₋₆alkyl or aryl; r is an integer from 0 to 20; p is 0 or 1; s is 0 or 1, with the proviso when s is 0, r is not 0; and optionally, —(CH₂)ᵣ— in formula R^{f}NHC(O)ₛ(CH₂)ᵣ(O)ₚ— is optionally substituted with from 1-2 substituents selected from C₁₋₈alkyl, aryl, halo, heteroaryl, —CN, —NO₂, hydroxyl and carboxyl.

38. The method of claim 37, wherein R^{f} and R⁶ are —H.

39. The method of claim 29, wherein said free radical generator is a peroxide or a diazo compound.

40. The method of claim 39, wherein the free radical generator is dicumyl peroxide.

41. A method for preparing a biocidal fiber, said method comprising:
contacting said graft polymer fiber of claim 1 with a halogen generating source under conditions sufficient to form a biocidal fiber.

42. The method of claim 29, wherein the halogen generating source is bleach.
